(19) United States
(12) Patent Application Publication
(10) Pub. No.: US 2004/0261025 A1
(43) Pub. Date: Dec. 23, 2004

(54) Method and system of providing secure on-line access to a database of documents

(76) Inventors: Thomas Rizk, Franklin Lakes, NJ (US); Michael A. Drawbaugh, Hackettstown, NJ (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/802,743

(22) Filed: Mar. 18, 2004

Related U.S. Application Data
(63) Continuation-in-part of application No. 09/748,105, filed on Dec. 27, 2000.

(51) Int. Cl. G06F 17/21

(52) U.S. Cl. 715/530

(57) ABSTRACT

The present invention provides for storing, organizing, managing and remotely accessing documents in a secure environment. Various levels of security control access to documents and specific information on the system based on user access privileges defined by roles of a user. A cover sheet including a standard set of identification data characterizing each document is created. A digital version of each contract is created and stored by scanning each document.

### CROSS-REFERENCE TO RELATED APPLICATIONS

This application is a continuation-in-part of U.S. application Ser. No. 09/748, 105, filed Dec. 27, 2001, now pending, The entire disclosure of this application is incorporated by reference herein.

### FIELD OF THE INVENTION

The present invention relates to a method, a system, and a computer program product for storing, organizing and providing remote access to documents over the Internet. More particularly, the present invention relates to a method, a system, and a computer program product for providing secure on-line access to a database of documents, such as contracts, and information related thereto.

### DESCRIPTION OF THE PRIOR ART

There are a number of organizations, institutions, and companies that engage in providing various goods and services to consumers. These business entities may include banks, financial service institutions, insurance companies, pharmaceutical companies, healthcare companies, real estate companies, food companies and law firms. Often providing these goods and services includes the use of some form of contract or agreement. In most cases, a variety of other documents and materials are also included as part of the contract or agreement, or related to providing the goods ands services in some capacity. Typically, the contract requires the performance of one or more activities. These activities may be subject to specific performance requirements and deadlines. The input, storage, management, update and tracking of this information to manage contractual obligations and relationships is necessary. However, these functions, when performed manually, can be very labor intensive.

Information Management Systems have been developed that purport to generate, store, manage, update, and track information, such as contracts and agreement, related documents and other information. Typically, these type of systems require that the entity implementing the system input the information and develop, update and maintain a database to support the system. This requires that the entity expends a substantial amount of resources in the form of hiring or contracting individuals to specifically perform these functions.

Depending on the entity, this process is performed at each of the entities regional locations creating a de-centralized work environment. In ADDition, each of the regional locations may perform different business functions, and thus, have specific requirements and documents. The de-centralized work environment can make the sharing of documents between the different regional locations quite difficult, and delay the decision making processes. As a result, operational efficiencies of the entity are not realized.

The services or goods provided in the operation of an entity's business may require that certain governmental procedures and regulations are followed with respect to the execution, performance, and structure of documents, such as contracts. Failure on the part of the entity to adhere to the regulations can result in the issuing of sanctions against the entity by the government, or the commencement of litigation. In order to mitigate sanctions against the entity by the government, or the commencement of litigation, these entities must demonstrate that they are adhering to the procedures and regulations. Often demonstrating that procedures and regulations are being followed requires that a business entity provide reports and other materials that convey what activities the business entity has performed. Production of these reports protects and strengthens a business entity's defensive position against litigation and sanctions by the government and consumers.

However, performing the necessary tasks to comply and demonstrate compliance with the procedures and regulations is often an arduous task. The generation of the requisite reports is one such task. These reports are tedious, time consuming, and difficult to generate. They require identifying and tracking the activities of individual professional employees as well as documents to obtain the data to be included in the reports. Tracking activities of employees and document is also as difficult a task.

### SUMMARY OF THE INVENTION

According to embodiments of the present invention a method, a system, and a computer program product for providing secure on-line access to a database of documents, such as contract information and information related thereto, for management and update are provided. The present invention provides for storing, organizing, managing and remotely accessing documents in a secure environment. Various levels of security control access to documents and specific information on the system based on user access privileges defined by roles of a user. A cover sheet including a standard set of identification data characterizing each document is created. A digital version of each contract is created and stored by scanning each document.

The documents and related information are searchable. Alerts are generated and sent to designated parties reminding them of critical dates associated with each document. Remote access to the documents is provided over the Internet. The monitoring of a document's compliance with governmental procedures and regulations, progress through a process, and performance requirements are also provided for. Reports are generated to provide financial and entity compliance overviews. The information documents stored on the system are modifiable by users based on users access privileges. The present invention, provides a cost effective system and method for managing and administering contract related business information, documents and services.

Still other objects and advantages of the present invention will become readily apparent by those skilled in the art from a review of the following detailed description. The detailed description shows and describes preferred embodiments of the invention, simply by way of illustration of the best mode contemplated of carrying out the present invention. As will be realized, the invention is capable of other and different embodiments and its several details are capable of modifications in various obvious respects, without departing from the invention. Accordingly, the drawings and description are illustrative in nature and not restrictive.

### BRIEF DESCRIPTION OF THE DRAWINGS

The above described features and advantages of the present invention will be more fully appreciated with reference to the detailed description and appended figures in which:

FIG. 1 depicts an exemplary block diagram of a system according to an embodiment of the present invention;

FIG. 2 depicts an exemplary block diagram of a system shown in FIG. 1 according to an embodiment of the present invention;

FIG. 3 depicts an exemplary block diagram of a system shown in FIG. 1 according to an embodiment of the present invention;

FIG. 4 depicts an exemplary block diagram of a system shown in FIG. 1 according to an embodiment of the present invention; and

FIGS. 5-55 represent web pages that illustrate aspects of a document management system according to one embodiment of the present invention.

### DETAILED DESCRIPTION OF THE INVENTION

According to embodiments of the present invention a method, a system, and a computer program product for providing secure on-line access to a database of documents, such as contract information and information related thereto, for management and update are provided. The present invention provides for storing, organizing, managing and remotely accessing documents in a secure environment. Various levels of security control access to documents and specific information on the system based on user access privileges defined by roles of a user. A cover sheet including a standard set of identification data characterizing each document is created. A digital version of each contract is created and stored by scanning each document.

The documents and related information are searchable. Alerts are generated and sent to designated parties reminding them of critical dates associated with each document. Remote access to the documents is provided over the Internet. The monitoring of a document's compliance with governmental procedures and regulations, progress through a process, and performance requirements are also provided for. Reports are generated to provide financial and entity compliance overviews. The information documents stored on the system are modifiable by users based on users access privileges. The present invention, provides a cost effective system and method for managing and administering contract related business information, documents and services.

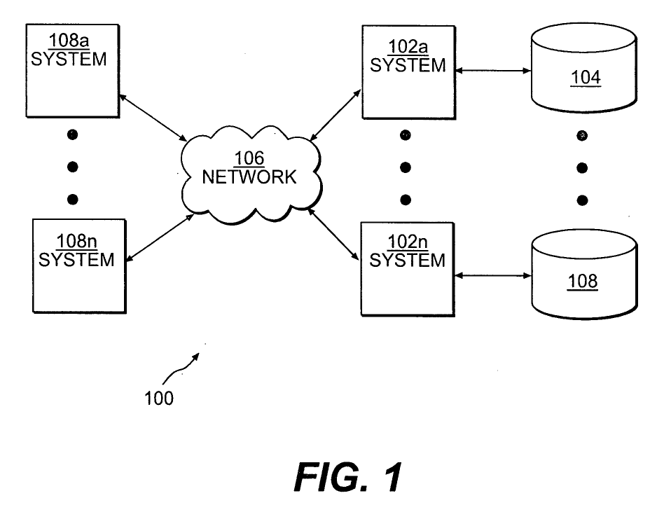

An exemplary block diagram of a system in which the present invention can find application according to an embodiment of the present invention is shown in FIG. 1. In the embodiment of FIG. 1, system 100 can be implemented to provide secure on-line access to, and storage and management of, a database of contract information and information related thereto. In the FIG. 1 embodiment of the present invention, system 100 includes systems 102a-102n, systems 104a-104n, network 106, systems 108a-108n. The system 100 can transmit, using the network 106, any combination of voice, video and/or data between systems 102a-102n, systems 104a-104n, and systems 108a-108n.

In the FIG. 1 embodiment of the present invention, the system 100 creates a database for documents, such as contracts, where an Electronic File Cabinet is developed for each document through which all activities related to the documents are stored. Management activities related to documents include, but are not limited to, contract management, critical data management and workflow management. Contract management functions include, but are not limited to searching, contract cover sheet generation, contract and certificate of insurance generation, contract notes and attachments generation, asset log generation, key term generation and printing.

The search function provides users with the ability to perform customized searches of their entire database, including full-text searches for key words and/or phrases, as well as keyword searches of contract attributes. The contract cover sheet generation function develops a cover sheet for every scanned document in a system 102. Application having Ser. No. 09/748,105 discloses methods of developing a cover sheet, the entire disclosures of which are incorporated by reference herein. The contract and certificate of insurance generation function provides an image copy of each scanned document in a read only format. The contract notes and attachments function superimposes all information, such as correspondence related to a contract, comments, side-letter agreements and notes of verbal communications as a permanent part of a contract record. Users can easily attach ADDenda to a contract file. The asset log function enables users to attach the name, serial number, location and other equipment and/or asset related information to a contract file. The key terms function generates a sheet(s) in each contract file for users to store key terms and provisions of an agreement and other information. The printing function offers users the option to print dated page(s) that contain all of the information from a contract cover sheet, a contract and attachments, the asset log and the key terms sheet.

Critical data management function provides users with advance notification of critical dates contained in the contracts stored in the database. Critical data management functions include, but are not limited to, CE-Mail advance alerts, critical event tracking, critical events calendar, and critical date list. The CE-Mail advance alerts provide designated responsible parties with CE-Mail notices in advance of contract expiration. The CE-Mail advance alerts may be sent at intervals including, but not limited to, 120 days, 90 days, 60 days, 30 days, 14 days, 7 days, and the day before the expiration date, as well as on the actual expiration date to remind the client to take actions necessary to ensure that contract terms and conditions are effectively managed and are negotiated timely. The system 100 gives the client time to assess with a fresh perspective the need for a particular agreement. If a responsible party does not respond to the CE-Mail advance alerts prior to contract expiration, the agreement will be recorded in an Action List until they take an action to renew the contract, enter a new term and expiration date, archive the contract in the system 100, or DELETE the contract from the system 100.

The critical events tracking function allows users to enter critical events, dates, and the corresponding contract page number contained in the body of a contract. Designated responsible parties will receive advance CE-Mail notices at intervals including, but not limited to, 120 days, 90 days, 60 days, 30 days, 14 days, 7 days, the day before and the day of the date/event reminding them of those events and dates. The critical event calendar function provides users with a variety of calendars depicting critical events and dates loaded into the system 100. The critical event calendar provides a direct link to the appropriate contract files. User access to the calendars is determined by security access, as defined by our clients. The critical date list provides managers and appropriately classified users with a comprehensive list of all critical dates entered. Upon clicking on a date, a user is provided with a link to the appropriate contract file.

The workflow management function provides users with the ability to route draft documents, make and receive comments to proposed agreements, make and receive black line changes to proposed agreements, and generate and store templates of documents. The workflow management function provides access to internal and external users professionals, via the Internet, for on-line negotiation of contracts. The workflow management function provides security access controls to Workflow Manager functionality separate from the security access controls for the document database. Externally generated documents can be scanned to Workflow Manager, converted to a Microsoft® Word document, and marked-up and negotiated on-line.

Document storage includes, but is not limited to, initially loading contracts into a database as active agreements and archiving the contracts once they expire or are terminated. Archived contract files including the contract summary sheet, a copy of the document, attachments, and notes input by users are readily accessible in the database. A status feature provides users with an alphabetical listing of all archived documents with links to the contract files.

In the FIG. 1 embodiment of the present invention, each of the systems 102 is coupled to systems 104a-104n, and systems 108a-108n via network 106. Each of the systems 102 can be provided at respective locations. Each system 102 can be any apparatus from which, and to which, any combination of voice video and/or data can be transmitted over a network 106, such as the Internet. In the FIG. 1 embodiment of the present invention, each of the systems 102 is a computer that includes, a display, input/output devices such as a scanner, keyboard and a printer. Each of the systems 102 can transmit documents and information, and receive requests for the execution of functions in accordance with the present invention.

In the FIG. 1 embodiment of the present invention, each of the systems 104 is coupled to system 108 via network 106. Each system 104 can be provided at respective locations. Each of the systems 104 can be any apparatus from which, and to which, any combination of voice video and/or data can be transmitted over a network 106, such as the Internet. In the FIG. 1 embodiment of the present invention, each of the systems 104 is a database that stores information and documents and performs document management functions in accordance with the present invention. The present invention contemplates that a respective system 104 may be provided in the same physical location as a respective system 102 or separate physical locations from a respective system 102.

In the FIG. 1 embodiment of the present invention, each of the systems 108 is coupled to network 106. Each of the systems 108 can be any apparatus from which, and to which, any combination of voice video and/or data can be transmitted over a network 106, such as the Internet. In the FIG. 1 embodiment of the present invention, each of the systems 108 can access system 102 to perform functions of the present invention and receive document and information employing network 106.

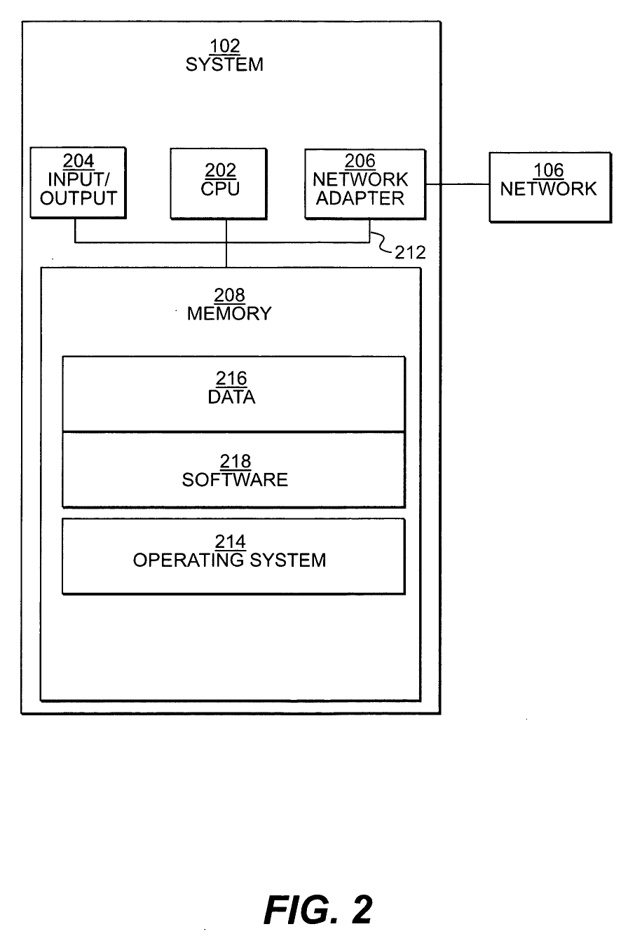

An exemplary block diagram of a system 102 of FIG. 1 which can find application according to an embodiment of the present invention is shown in FIG. 2. In the FIG. 2 embodiment of the present invention, system 102 includes input/output device interface, and display interface 204 and network adapter 206, system memory 208 and CPU 202. The CPU 202 is connected by a bus 212 or other suitable interface means to system memory 208, input/output device interface, and display interface 204 and network adapter 206. The CPU 202 executes program instructions in order to carry out the functions of the present invention.

Input/output device interface 204 provides the capability to input data to, or output data from, system 102. Input/output device interface 204 includes, but is not limited to, input devices such as scanners, keyboards, etc., output devices such as video, monitors, printers, etc., and input/output devices such as dialers/modems, etc. Input/output device interface 204 enables input of data and documents, as well as output of reports, email alerts, documents, and search results. Network adapter 206 interfaces system 102 with network 106.

System memory 208 stores program instructions that are executed by, and data that are used and processed by, CPU 202 to perform the functions of system 102. System memory 208 can include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which can use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the FIG. 2 embodiment of the present invention, system memory 208 includes operating system 214, data 216 and software 218. Operating system 214 provides overall system functionality. The data 216 may include any information required to perform the functions of the present invention. The software 218 provides the functionality of the present invention including, but not limited to, receiving and transmitting data and documents as well as generating reports, distributing documents, issuing alerts.

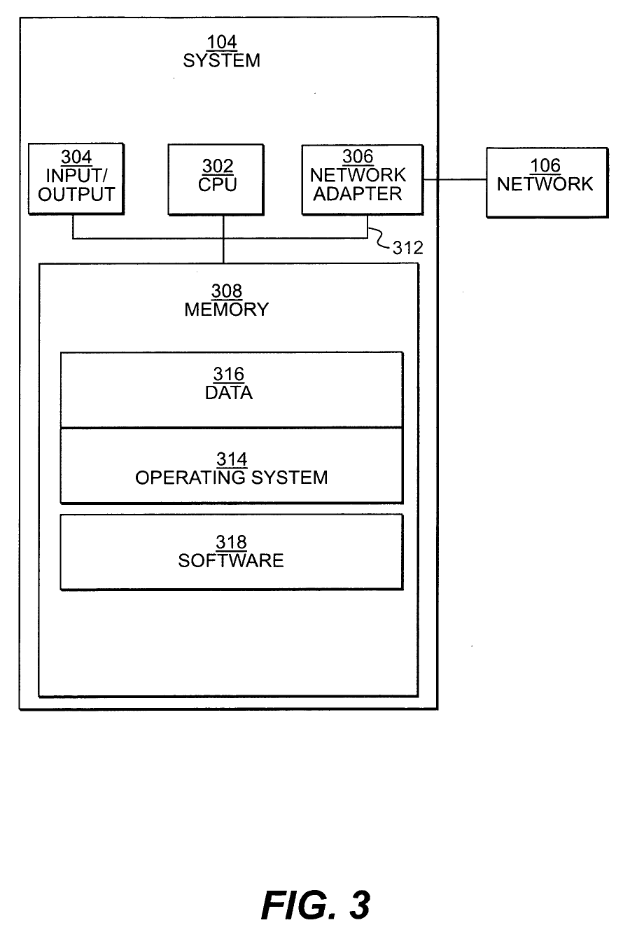

An exemplary block diagram of a system 104 of FIG. 1 which can find application according to an embodiment of the present invention is shown in FIG. 3. The system 104 shown in FIG. 3 may be a database management system that includes data for retrieval by system 102 and 108 and employed by system 100 to perform the functions associated with the present invention In the FIG. 3 embodiment of the present invention, the system 104 includes input/output device interface, and display interface 304 and network adapter 306, system memory 308 and CPU 302. The CPU 302 is connected by a bus 312 or other suitable interface means to system memory 308, input/output device interface, and display interface 304 and network adapter 306. The CPU 302 executes program instructions in order to carry out the functions of the present invention.

Input/output device interface 304 provides the capability to input data to, or output data from system 104, such as contracts, documents and information. Network adapter 306 interfaces system 104 with network 106.

System memory 308 stores program instructions that are executed by, and data that are used and processed by, CPU 302 to perform the functions of system 104. System memory 308 can include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which can use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the FIG. 3 embodiment of the present invention, system memory 308 includes operating system 314, data 316 and software 318. Operating system 314 provides overall system functionality. The data 316 can include, but is not limited to, documents, contracts, agreements and any other information generated in the course of business by entities, such as banks, financial service institutions, insurance companies, pharmaceutical companies, healthcare companies, real estate companies, food companies and law firms. The software 318 provides the functionality for retrieving, maintaining, managing and searching data according to embodiments of the present invention.

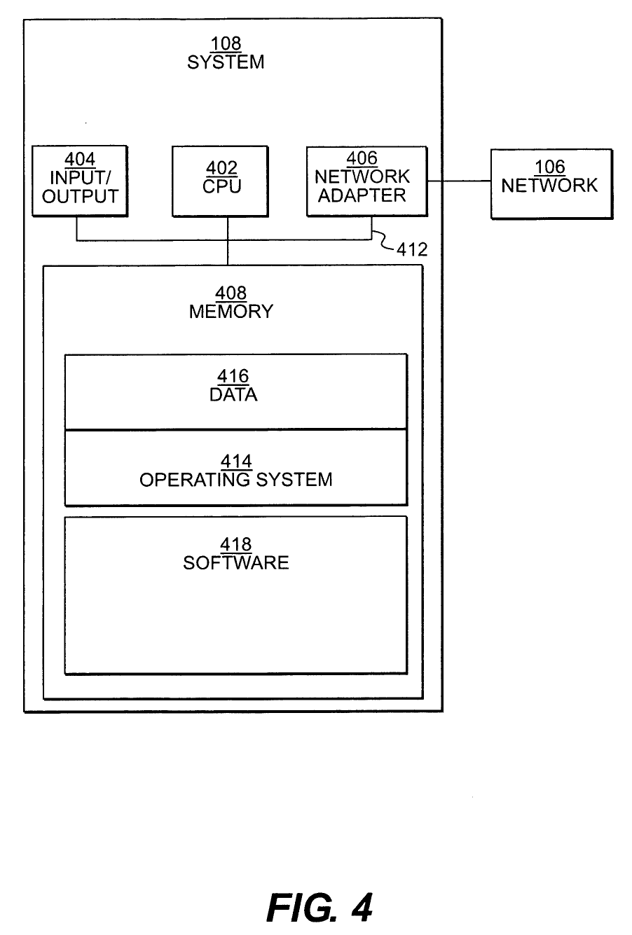

An exemplary block diagram of a system 108 of FIG. 1 which can find application according to an embodiment of the present invention is shown in FIG. 4. The remote end user systems 108 shown in FIG. 4 may include CPU 402, connected by a bus or other suitable interface means to system memory 408. The remote end user system 108 can also include input/output device interface, and display interface 404. Input/output device interface 404 enables interaction with and execution of instruction by user system 108 as directed by a user to remotely access system 102 to perform functions. Display interface can display information generated for output by user system 108 as provided by system 102. As shown, the various components of the user system 108 communicate through bus 418 or similar architecture. Accordingly, systems memory 408 is disposed in communication with CPU 402 through bus 418. Systems memory 408 includes Browser Program 412, operating system 414 and data 416.

Operating system 414 provides overall system functionality. Browser program 412 implements computer program instructions executed by CPU 402. The browser program 412 enables the information transmitted from system 102 to be conveyed to a user in a manner that can be understood by a user of user system 108. The browser program 412 serves as a front end to the World Wide Web on the Internet. The browser program 412 may be used to display information retrieved from system 102, such as documents, information, reports and the like over network 106.

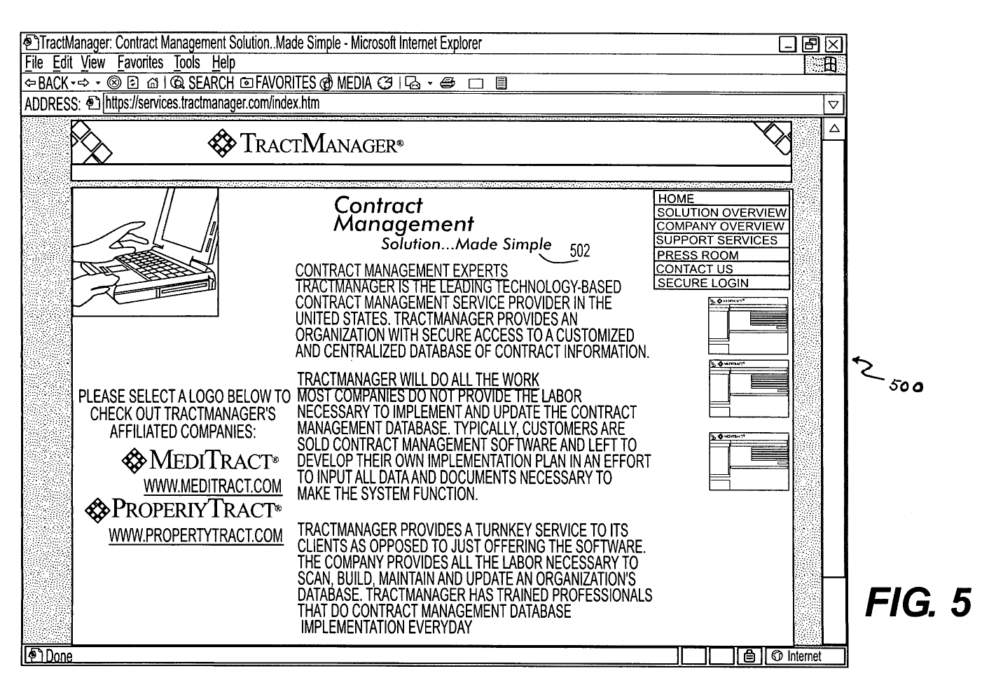

FIG. 5 illustrates an example of a web page according to the present invention. In the FIG. 5 embodiment of the present invention, a homepage 500 relates to a website providing contract management services. Homepage 500 provides access to the contract management services and functions of the present invention. The homepage 500 may include a plurality of user selectable options including, but not limited to, login, overviews, and services. The selection of the login option 502 generates prompts for user entry of a user name and a password. The password and user name may be provided through registration of the user to the website by an administrator of the website. A verification process determines whether the user is authorized to access the system based on the combination of the user name and password. The user name and password may be classified to a level of access rights/privileges based on a user's role within an entity.

The levels of access include, but are not limited to, a report, a reviewer, an author, an editor, an administrator, and a systems administrator. The reporter level of access is read-only to all of the information pertaining to the documents and information they have been granted access privileges to view. However, they are not allowed to view the document, such as an Original Contract PDF document image.

The reviewer level of access is read-only to all of the information pertaining to the documents and information they have been granted access privileges to view. The author level of access provides the same access as a reviewer as well as an ability to create and read documents notes, attachments, critical dates, and assets in the database. Overall, the author level of access provides the ability to see modification options, such as ADD option, on appropriate pages in order to keep necessary information relating to a document.

The editor access level provides all of the access privileges of an author level of access as well as provides the ability to create and EDIT a contract summary page, archive a contract, enter critical dates, create and EDIT asset logs and vendor files, receive email notifications, and be named as a responsible party for a contract. Overall, the Editor level of access provides the ability to see modification options, such as an EDIT option, on the appropriate pages in order to EDIT any necessary information relating to a document.

The administrator level of access provides all of the access privileges of an editor as well as the ability to perform DELETE modifications to an appropriate page. An administrator may also make changes to a user's access privileges and hierarchy in the database. Overall, the Administrator level of access provides the ability to see modification options, such as a DELETE option on the appropriate pages in order to DELETE any necessary information relating to a document.

The system administrator level of access provides all of the access privileges of an Administrator as well as the ability to reset user passwords. This role should only be given to one person of an entity the choices an entity has to classify access privileges of each user provides a security tool whereby management can control by each user using the present invention.

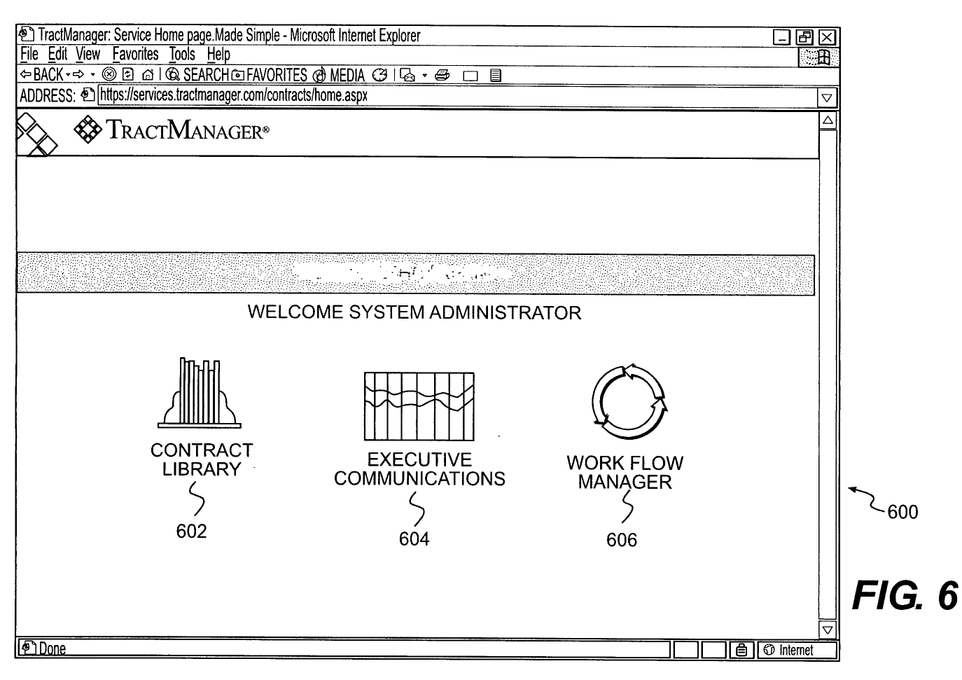

FIG. 6 depicts an exemplary gateway web page that provides a gateway to secure areas of information stored in a system 102 according to an embodiment of the present invention. In the FIG. 6 embodiment of the present invention, the gateway web page 600 includes selectable icons. One or more of the icons may not be displayed based on the access privileges of a user. The contract library icon 602 provides a user with access to a database of contracts and information intended solely for that user based on their access privileges. The executive communication icon 604 provides users with the appropriate access privileges, a secure location to communicate tips, observations and updates about system's 100 use and operation. The workflow manager icon 606 provides users with the appropriate access privileges to the system 102 to perform a workflow process for the creation, approval and routing of new documents. The workflow manager icon 606 may also be used to provide access to a repository of template documents and/or working drafts.

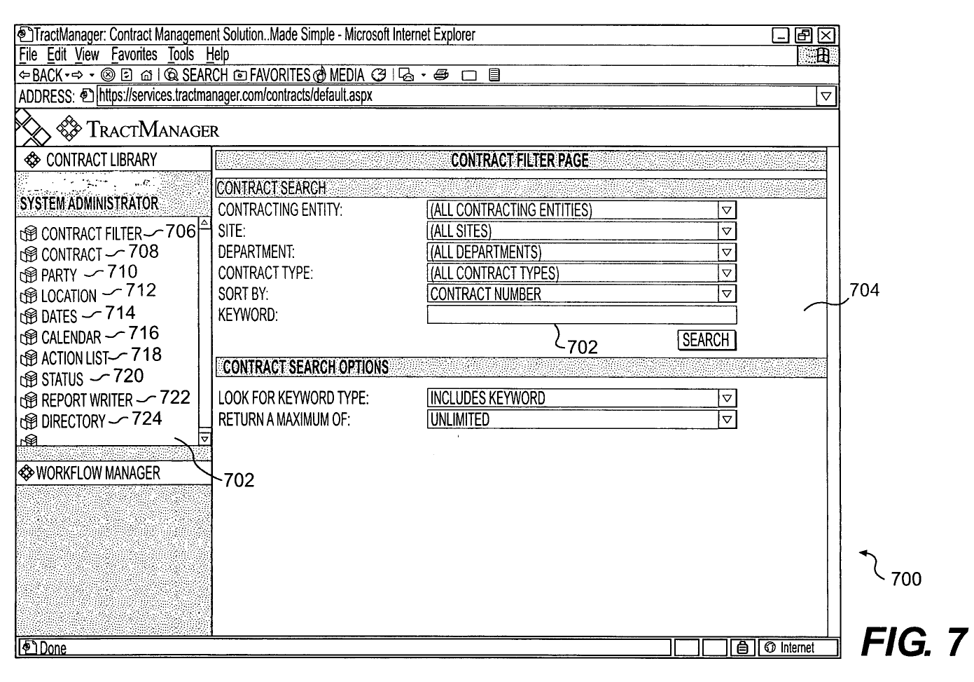

FIG. 7 depicts an exemplary web page that is provided upon selection of the contract library icon 602 shown in FIG. 6. In the FIG. 7 embodiment of the present invention, the web page 700 performs functions on contracts stored in a database. The contract library web page 700 includes a navigation panel 702, and an information content panel 704. The navigation panel 702 provides options to perform functions on contracts. The options include, but are not limited to, contract Filter 706, contract 708, party 710, locations 712, dates 714, calendar 716, Action list 718, status 720, report writer 722 and directory 724. The selection of an option in navigation panel 702 navigates the user to a web page to enable the performance of functions related to a selected option. The content panel 704 provides information options, required to perform the function related to a selected option. Each option in navigation panel 702 may have one or more sub-options.

In the FIG. 7 embodiment, the web page is a contract filter web page provided in response to the selection of the contract filter option. The page provides users with the tools to undertake customized searches of their entire database including full-text searches for keywords and/or phrases from the contract attributes. The content panel of contract filter web page 700 includes a contract attribute search section 726. The contract attribute search section 726 provides a user with the ability to develop a subset of their database by defining the filters categories including a contracting entity category 728, a site category 730, a department category 732, and a contract type category 734. By clicking on the drop down boxes next to each category a user may conduct a word and/or phrase search of the subset. Search results provide users with a direct link to the contract file.

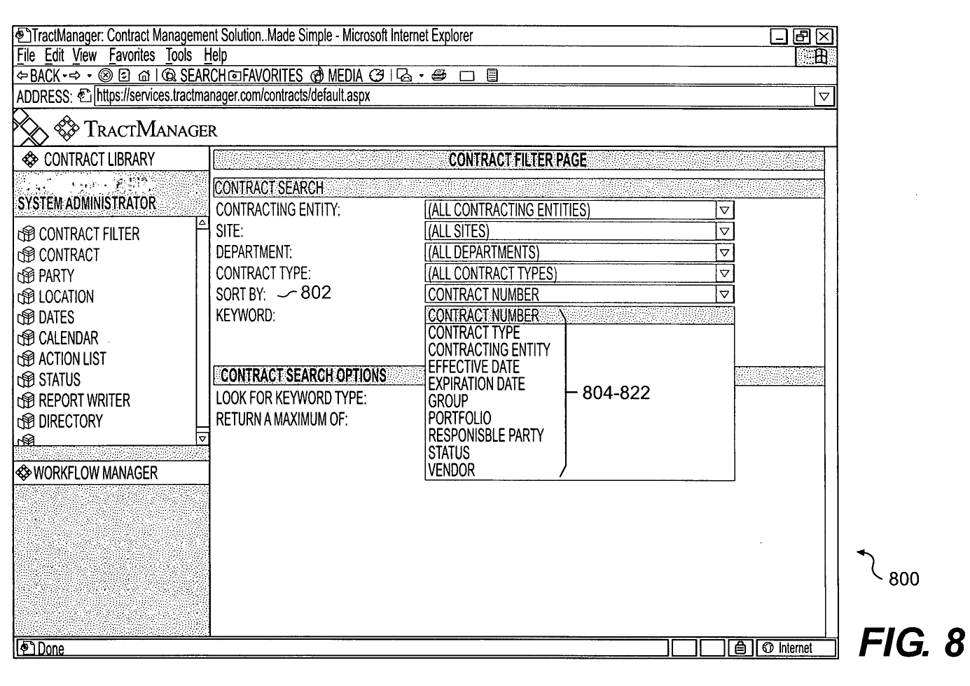

FIG. 8 depicts an exemplary web page that is provided upon selection of the contract library icon 602 shown in FIG. 6. In the FIG. 8 embodiment of the present invention, the selection of the contract filter icon 824 from the navigation panel 826 provides the contract filter web page 800. The contract filter web page 800 provides a sort by field 802 category to allow users to specify how the search results will appear. In the FIG. 8 embodiment of the present invention, sort by options include, but are not limited to, contract number 804, contract type 806, contracting entity 808, department 810, effective date 812, expiration date 814, group 816, responsible party 818, status 820 and vendor 822. In addition, users can conduct keyword searches of all contracts and attachments, vendor files or a subset of the database, and can determine how many records are returned for each search.

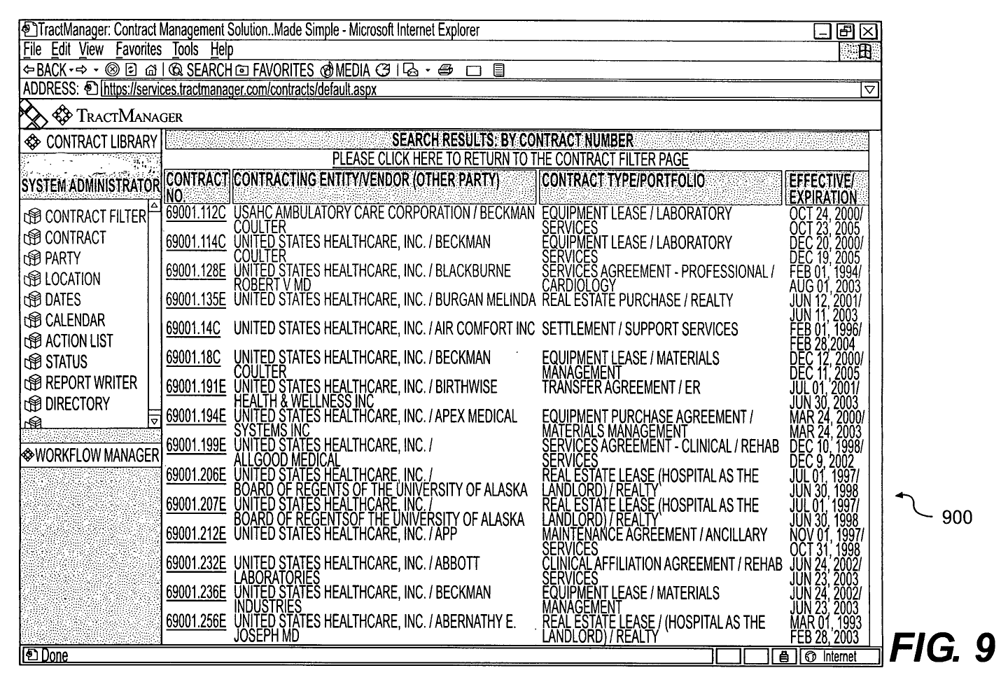

FIG. 9 depicts an exemplary web page that provides a view of search results of a keyword search performed from the contract filter web page 800 shown in FIG. 8. In the FIG. 9 embodiment of the present invention, the view of results is sorted by contract number. All search result views provide users with a direct link to the individual contract files listed in search results. In the view of FIG. 9 an underlined contract number navigates users to the contract file.

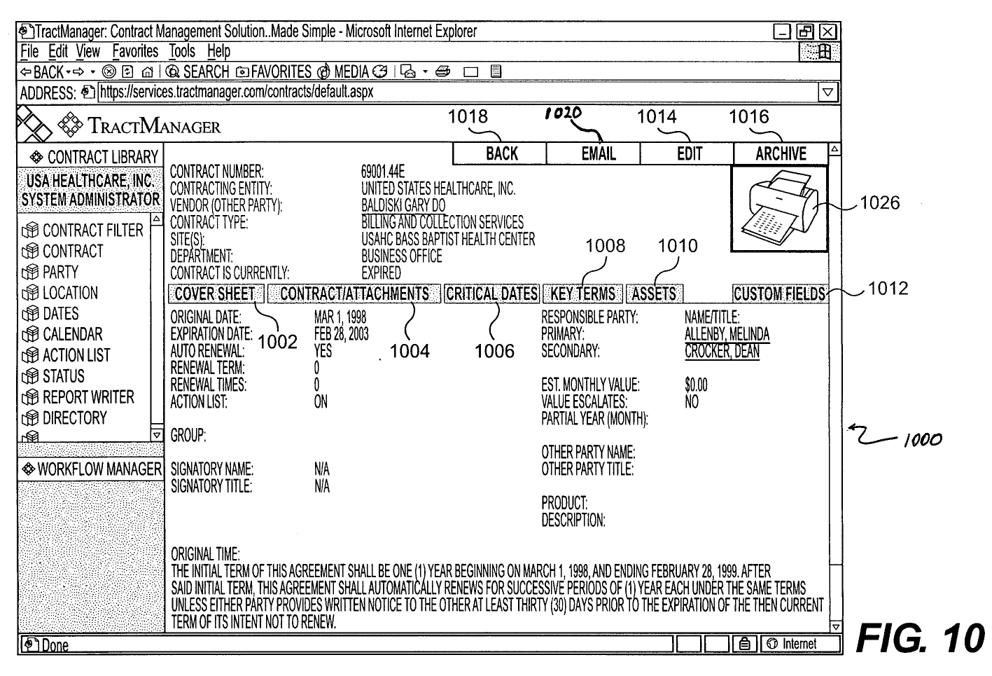

FIG. 10 depicts an exemplary web page that provides information about a selected contract listed in the search result shown in FIG. 9. In the FIG. 10 embodiment of the present invention, a contract summary page 1000 provides information about a contract. A contract summary page 1000 will display the information for a contract number, the contracting entity, the vendor, the contract type, the site(s), the department, and the current status of the contract. The status of the contract may be a countdown of days until the contract expires, or on archived until date. Detailed information about the contract is accessible using tabs that include, but are not limited to, a cover sheet tab 1002, a contracts/attachments tab 1004, a critical dates tab 1006, a key terms tab, 1008, an assets tab 1010 and a custom fields tab 1012. The summary page also provides options including, but not limited to, back 1018, email, EDIT 1014, archive 1016 and printer friendly icon 1026.

In the FIG. 10 embodiment of the present invention, the cover sheet tab 1002 lists items including, but not limited to, original date, expiration date, signatory name, title, the term of the agreement and the parties responsible for managing this contract. All of this information may be input to a system 102 at the time a database 104 is built. The cover sheet tab 1002 may also provide other fields for users to input additional information including, but not limited to, description 1018, group 1020, responsible party job titles 1022, product 1024, and per square foot value 1026. In the FIG. 10 embodiment of the present invention, responsible party names may be provided as links to users immediate access to e-mailing capabilities of existing e-mail system of 102. The selection of a link will initiate the e-mail system.

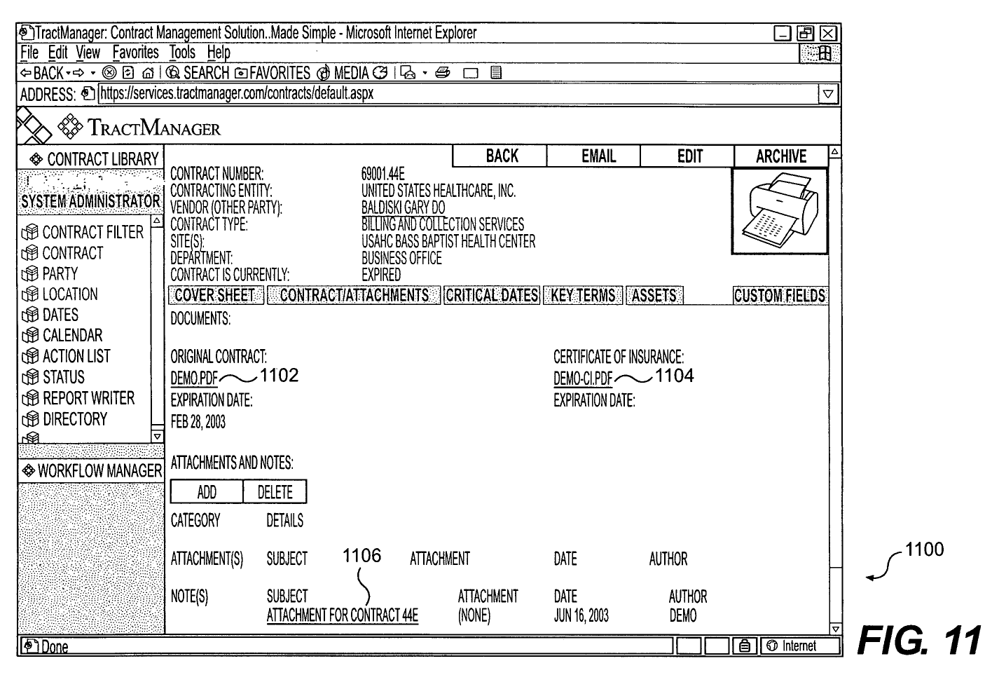

In the FIG. 11 embodiment of the present invention, the contract attachment tab 1004, shown in FIG. 10, allows users to gain access to options including original contract 1102, Certificate of Insurance 1104, and any contract attachments/notes 1106. Users may view the original contract by selecting the original contract option 1102. Users may view a Certificate of Insurance by selecting the Certificate of Insurance 1104 option. Users may view contract attachments by selecting the contract attachments/notes option 1106.

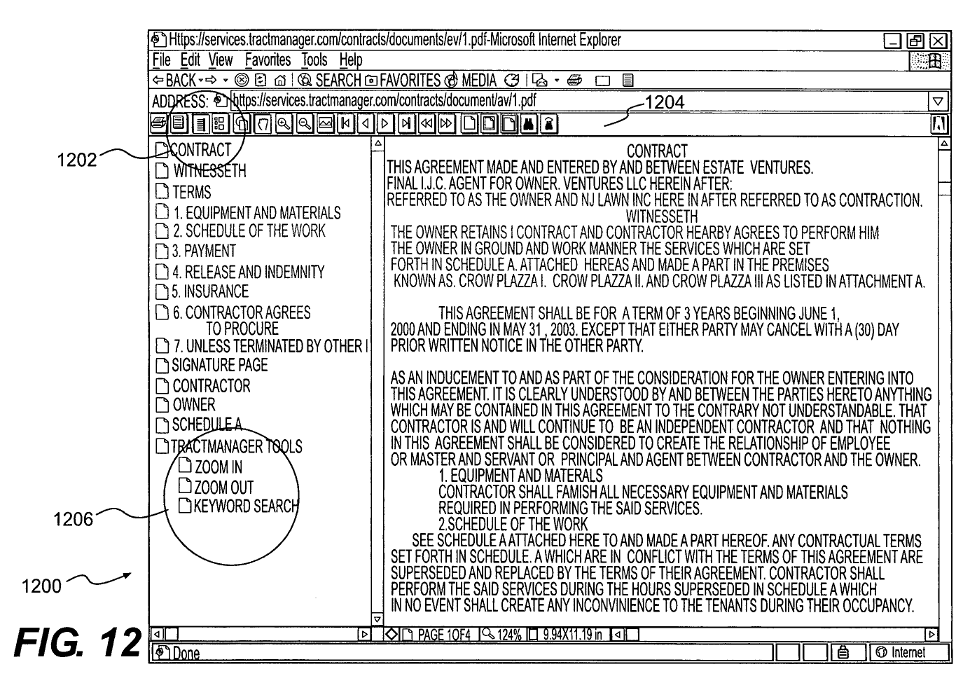

FIG. 12 depicts an exemplary image of a scanned document in read only format. Each system 102 provides an electronic index of documents eliminating the need for users to scroll through pages of documents. In the FIG. 12 embodiment of the present invention, a show/hide navigation pane icon on the toolbar 1202 is shown. The selection of the show/hide navigation pane icon 1202 navigates users to an electronic index. An Adobe® toolbar 1204 provides users with the ability to print, copy and paste a document, or portion thereof. Tools 1206 enables users to zoom in or zoom out to key sections of the document as well as enables the user to conduct a keyword search the document by selecting the corresponding index word.

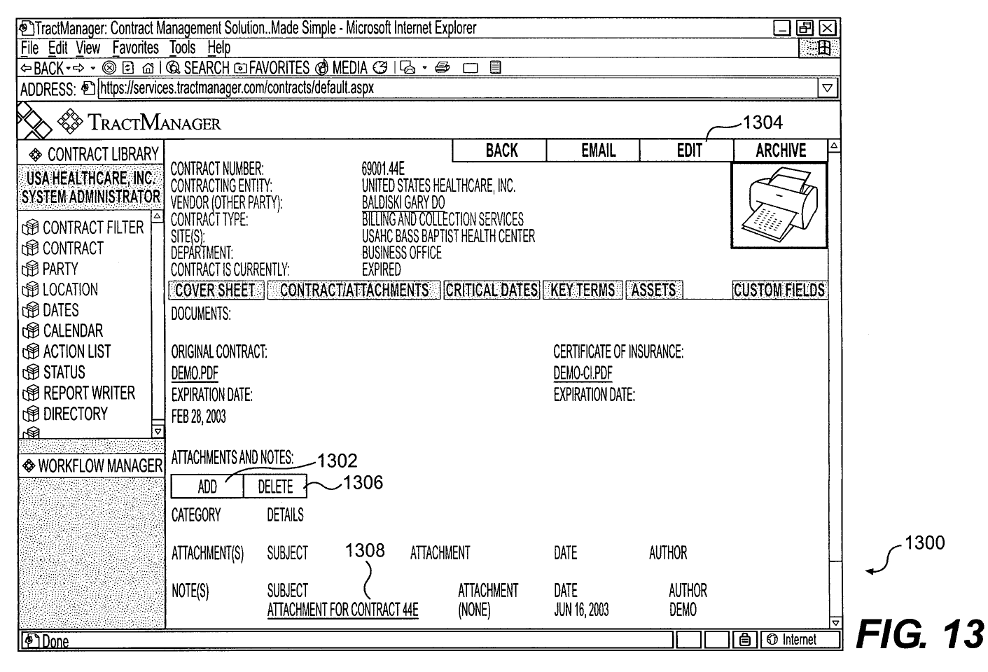

FIG. 13 depicts an exemplary view of a web page provided by selecting the contract attachment tab 1004 shown in FIG. 10. In the FIG. 13 embodiment of the present invention, options are provided including ADD 1302, EDIT 1304, DELETE 1306, and Attachment/Note 1308. The options are provided depending on the access privileges of the user. The options provide users with the appropriate access privileges to ADD, EDIT, and DELETE any attachments or notes that are associated with each contract. In the FIG. 13 embodiment of the present invention, the ADD option 1302 will navigate the user to a “Contract Attachment/Note—Add” page where information for a new attachment/note may be ADDed. The DELETE option 1306 will navigate the user to a “Contract Attachment/Note—Delete” page that displays all of the attachments/notes associated with that contract in a list so you can select one or more items to DELETE. The selection of an Attachment/Note option 1308 will navigate a user to a “Contract Attachment/Note Display” page that will allow a user to perform all of the above actions through a series of options that are located at the top of that page.

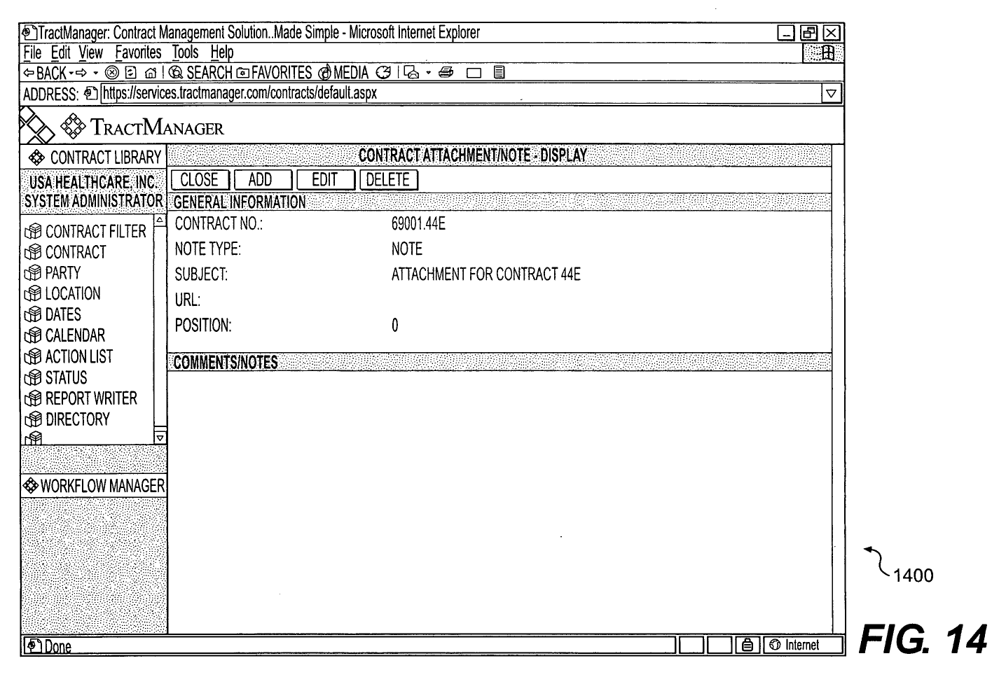

FIG. 14 depicts an exemplary view of an Attachment/Note display web page. The Attachment/Note display web page 1400 provides attachment options that are associated with the displayed Attachment/Note. In the FIG. 14 embodiment of the present invention, the attachment options include contract number 1402, note type 1404, subject 1406, URL position 1408, and comments/notes 1410. The attachment/note web page 1400 permits the information for an Attachment/Note to be added, edited, or deleted simply by selecting the option for each task. For example, selection of the DELETE option from this page will DELETE the attachment/note being viewed. The selection of the EDIT option will change the information for this attachment/note. The close option navigates users back to the Contract/Attachments tab.

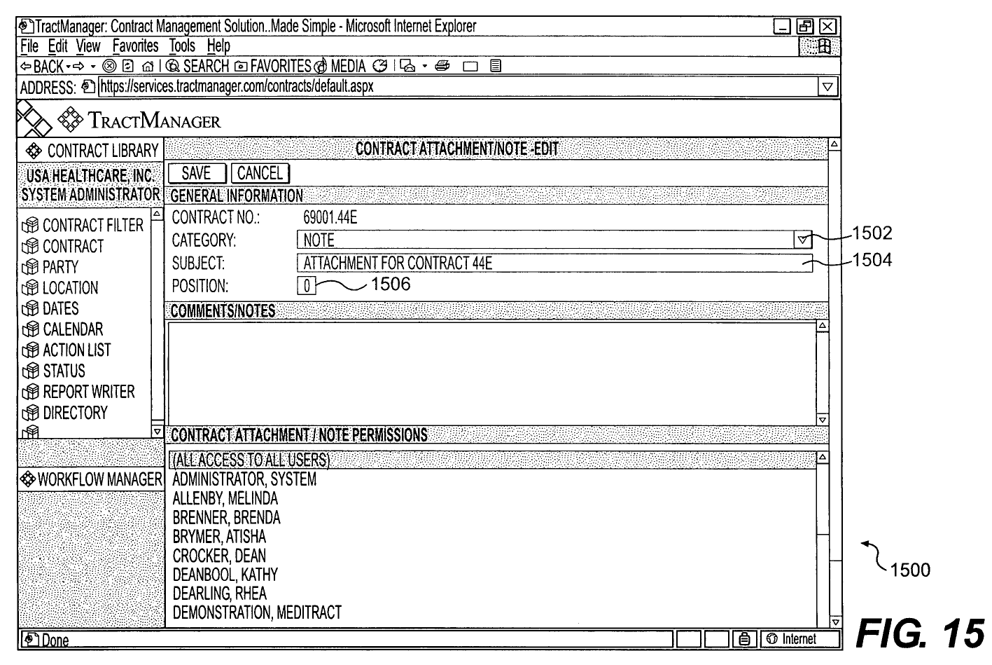

FIG. 15 depicts an exemplary view of an Attachment/Note EDIT web page. The Attachment/Note EDIT web page 1500 allows a user to change the above information for the Attachment/Note. A drop down text box options include, but are not limited to, category 1502, subject 1504, and position 1506 can, respectively, allow a user to change the Category, the Subject, the Position, and any Comments/Notes. In the FIG. 15 embodiment of the present invention, the Attachment/Note EDIT web page 1500 also has the ability to set necessary access privileges in the event that not all users should see the item that is to be attached to the contract. Any required information should be entered prior to saving this page. The cancel option 1508 provides the ability to exit the page without any changes being made. The save option 1510 saves a user's changes and navigates the user back to the “Contract Attachment/Note Display” page 1400.

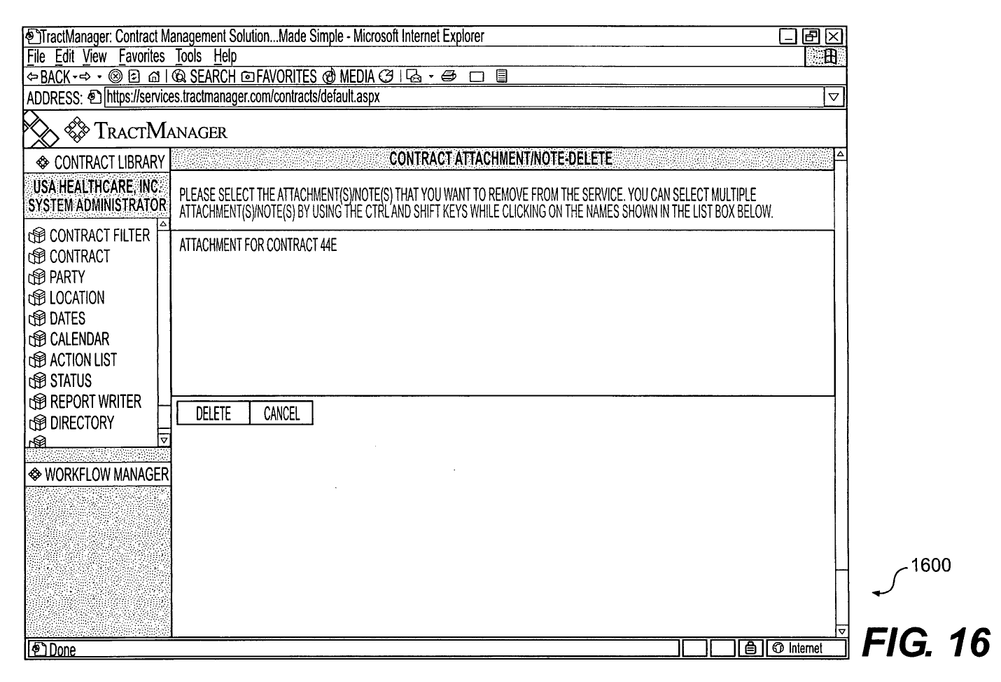

FIG. 16 depicts an exemplary view of an Attachment/Note DELETE web page. The Attachment/Note DELETE web page 1600 allows a user to change the above information for the Attachment/Note. In the FIG. 16 embodiment of the present invention, multiple items may be selected for deletion. The deletion of multiple items may be performed by techniques including depressing and holding the CTRL option and depressing and holding the SHIFT option. Depressing and holding the CTRL option selects random items to be deleted while selecting with your mouse pointer the different Attachments/Notes to be deleted. Depressing and holding the SHIFT option selects multiple items that are all in a row. Once items are highlighted, the selection of the DELETE option will DELETE the item or items and navigate the user back to the Contract/Attachment tab on the “Contract Summary Page”.

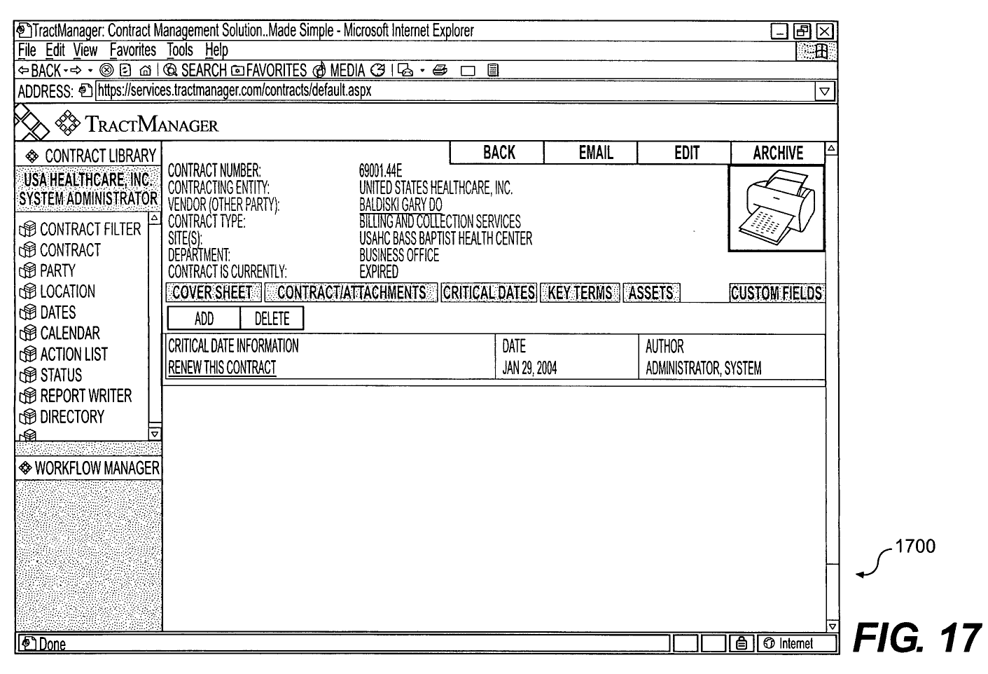

FIG. 17 depicts an exemplary view of a web page provided by selecting the critical data tab 1006 shown in FIG. 10. In the FIG. 17 embodiment of the present invention, the critical date page 1700 provides critical dates that are associated with this contract. The critical date page 1700 may provide options to modify critical dates including ADD 1702, EDIT 1704, and DELETE 1706. The options provide users with the appropriate access privileges ability to ADD, EDIT, and DELETE any critical dates that are associated with each contract. In the FIG. 17 embodiment of the present invention, the ADD option 1702 navigates the user to a “Contract Critical Date—Add” page where information for a new critical date may be added. The DELETE option 1706 will navigate the user to a “Contract Critical Date—Delete” page that displays all of the Critical Dates associated with that contract in a list so you can select one or more items to DELETE.

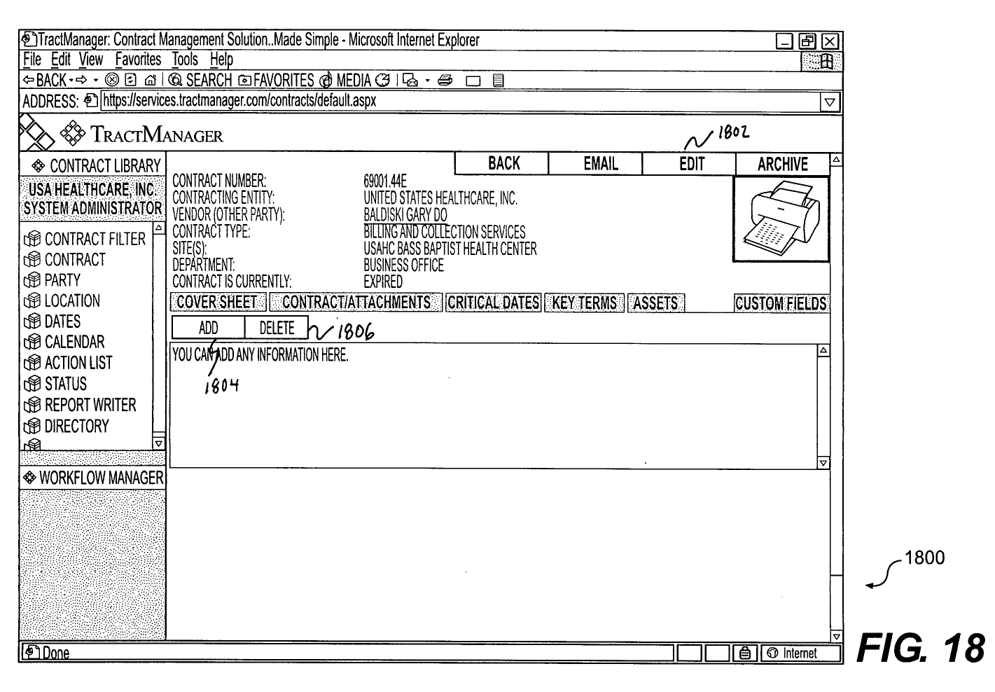

FIG. 18 depicts an exemplary view of a web page provided by selecting the key terms tab 1008 shown in FIG. 10. In the FIG. 18 embodiment of the present invention, the key terms page 1800 allow users to store key terms, provisions, and other information pertaining to an agreement. The key terms page 1800 allows access to this information without searching the actual contract document. An EDIT key terms option 1802 allows key terms that are listed on this page to be edited. The key terms page 1800 may include options ADD 1804, and DELETE 1806, any key terms, provisions, and other information pertaining to an agreement according to a user's authorized level of access. The options provide authorized users with the ability to ADD, EDIT, and DELETE any key terms, provisions, and other information pertaining to an agreement. In the FIG. 18 embodiment of the present invention, the ADD option 1802 will navigate the user to a “Contract Key terms—Add” page where key terms, provisions, and other information pertaining to an agreement may be added. The DELETE option 1806 will navigate the user to a “Contract Key Terms—Delete” page that displays all of the key terms, provisions, and other information pertaining to an agreement associated with that contract in a list so you can select one or more items to DELETE.

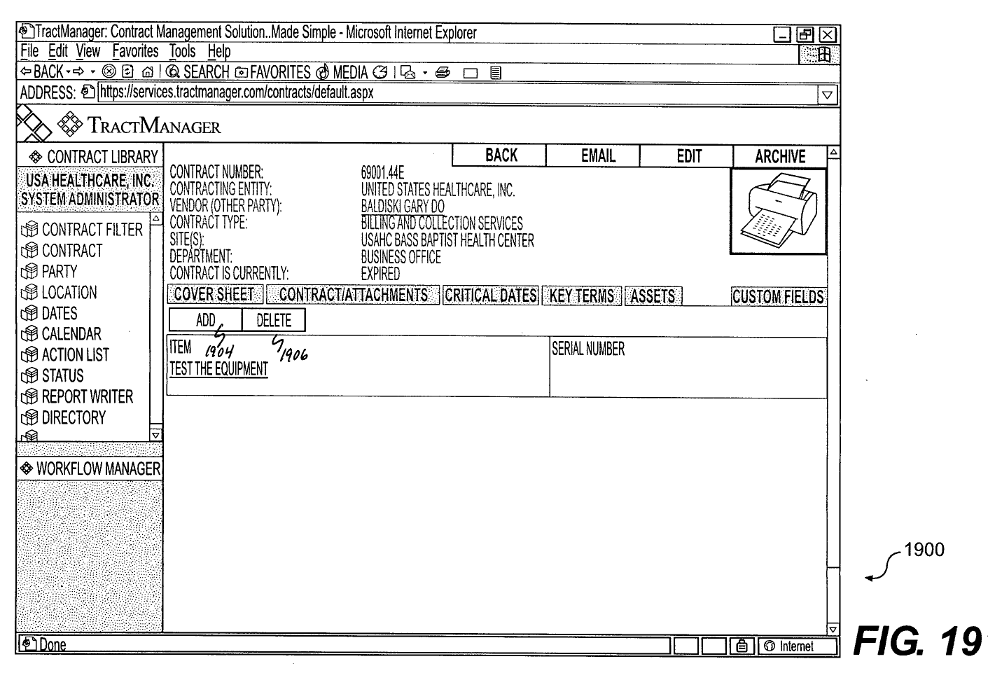

FIG. 19 depicts an exemplary view of a web page provided by selecting the asset tab 1010 shown in FIG. 10. In the FIG. 19 embodiment of the present invention, the assets page 1900 allows access to assets that are associated with the contract based on user access privileges. A modification option 1902 allows asset information that is listed on this page to be edited. The assets page 1900 may include other modification including, but not limited to, options ADD 1904, and DELETE 1906. The modification options provide authorized users with the ability to ADD, EDIT, and DELETE any asset information pertaining to an agreement. In the FIG. 19 embodiment of the present invention, the ADD option 1902 will navigate the user to a “Contract asset—Add” page where asset information pertaining to an agreement may be added. The DELETE option 1906 will navigate the user to a “Contract asset—Delete” page that displays all asset information pertaining to an agreement associated with that contract in a list. Items on the asset list may be deleted.

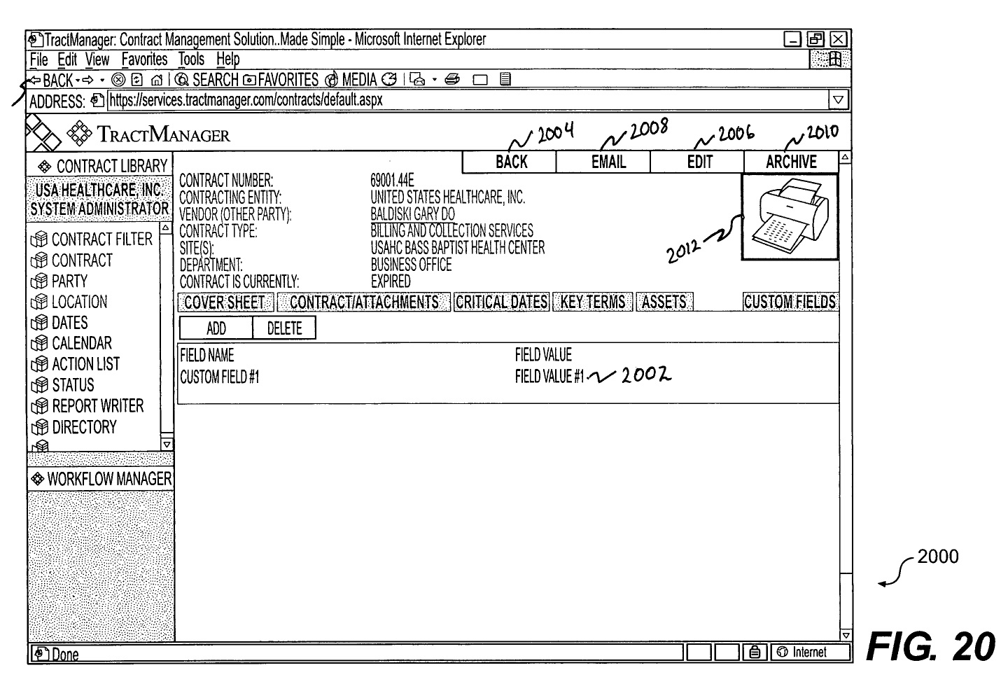

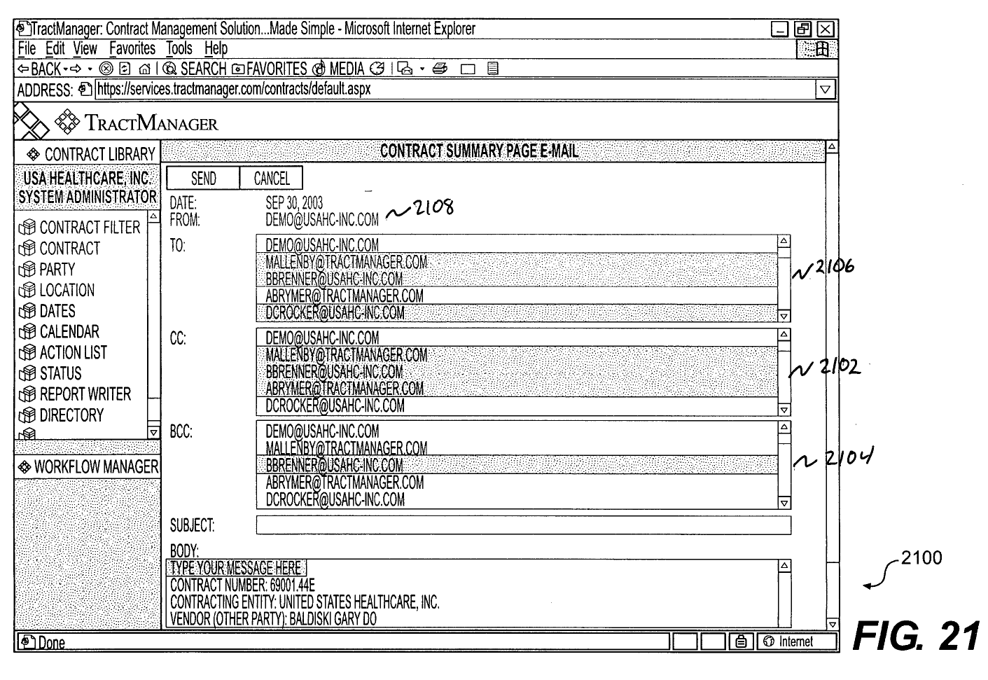

FIG. 20 depicts an exemplary view of a web page provided by selecting the custom field tab 1012 shown in FIG. 10. In the FIG. 20 embodiment of the present invention, the custom field page 2000 allows users to apply specific items of information to each of their contracts in order to find them easily within a system 102, and gain additional informational items not already included as part of the “Contract Summary Page”. The custom field tab 1012 may be populated with information provided by each entity. Once the information is entered a user, can then change field values 2002 in accordance with their access privileges. All of the information that is entered can then be searched, filtered, and displayed on the custom fields view under the contract heading on the navigation pane. They are also available using the “Contract Filter” page to produce search results.

The custom field page 2000 may provide options including, but not limited to, back 2004, EDIT 2006, email 2008, archive 2010 and printer friendly 2012. The back option 2004 navigates a user back to the page last viewed. The selection of the email option 2008 navigates users to a “Contract Summary Page Email” page that allows users to E-mail the information about that particular contract to other users of the system 100.

FIG. 21 depicts an exemplary view of a web page provided by selecting the custom field tab 1012 shown in FIG. 10. In the FIG. 20 embodiment of the present invention, the “Contract Summary Page Email” page 2100 allows users to send information about a particular contract to a list of users. In the FIG. 21 embodiment of the present invention, the “Contract Summary Page Email” page 2100 provides multiple item list boxes including To 2106, CC (Carbon Copy) 2102, and BCC (Blind Carbon Copy) 2104. In the FIG. 21 embodiment of the present invention, the multiple item list boxes To 2106, CC (Carbon Copy) 2102, BCC (Blind Carbon Copy) 2104 allow multiple users to be selected. A person sending the email will have their email Address inserted automatically in the From section 2108. We also have the current date automatically inserted into the Date section 2110, and within the text of the e-mail the basic contract information along with a link back to the contract is inserted.

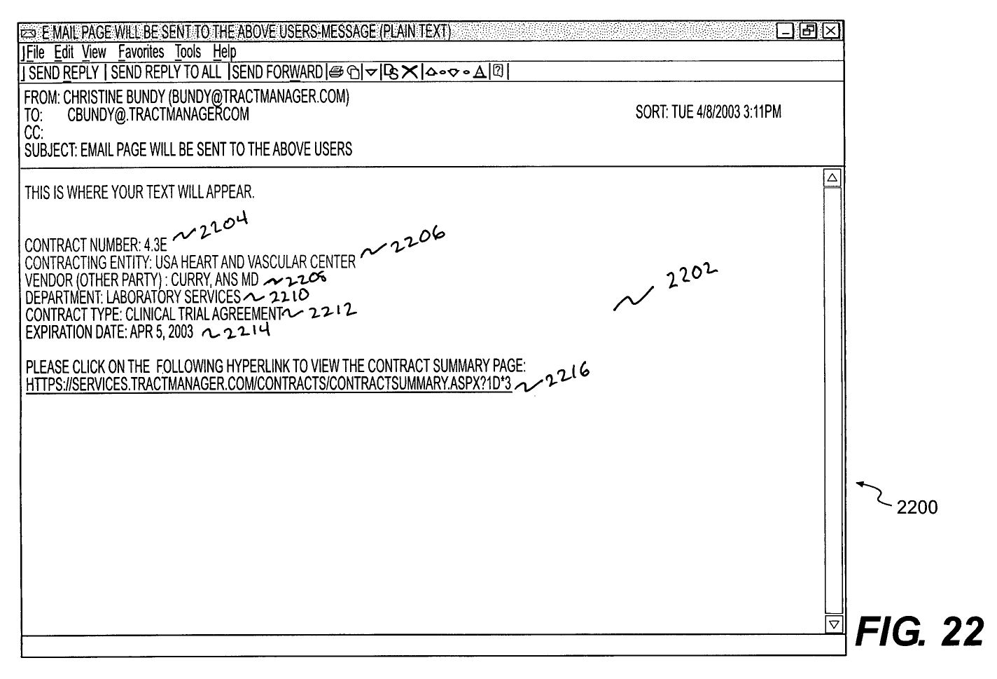

FIG. 22 depicts an exemplary view of an email received according to an embodiment of the present invention. In the FIG. 22 embodiment of the present invention, the “email” 2200 includes a body of the E-mail 2202, a Contract Number 2204, a Contracting Entity 2206, a Vendor (Other Party) 2208, a Department 2210, a contract type 2212, an expiration date 2214, and a link 2216. The body 2202 will include inserted text. The link 2216 navigates users to prompt for their user name and password. Once the information is entered, they will be navigated back to the “Contract Summary Page” for that contract in accordance with access privileges to the contract.

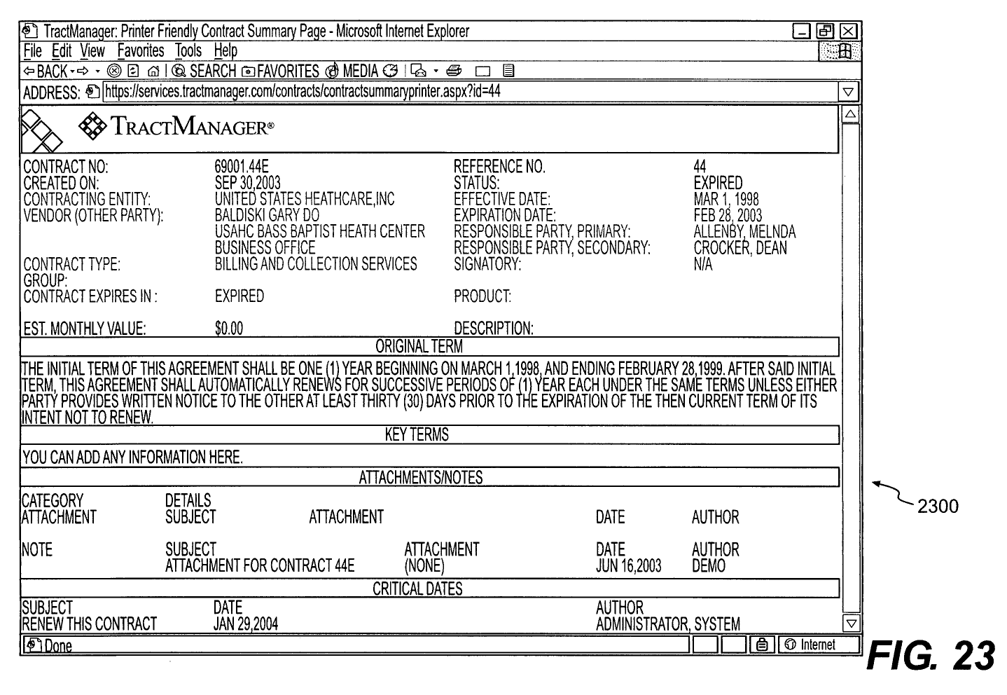

FIG. 23 depicts an exemplary view of a web page according to an embodiment of the present invention. In the FIG. 23 embodiment of the present invention, “the printer friendly contract summary” page 2300 includes all of the information about the contract in a printer friendly version. A printer icon 2302 is provided for printing of the information.

Returning to FIG. 10. The Archive option 1016 enables active and expired contracts to be archived by users in accordance with access privileges. A contract may be selected for archival from pages including a contract summary page for the contract, and a expired only page (not shown). The selection of the archive option 1016 displays a “Contract Summary Page—Archival” (not shown). The “Contract Summary Page—Archival” includes a drop down box to select a length of time to archive the contract. The selection of the archive option 1016 option on the “Contract Summary Page—Archival” navigates the user back to the “Contract Summary Page” where the status of the contract will be modified to specify that the contract is archived until the length of time selected. To archive a current contract, the expiration date must be edited for the contract.

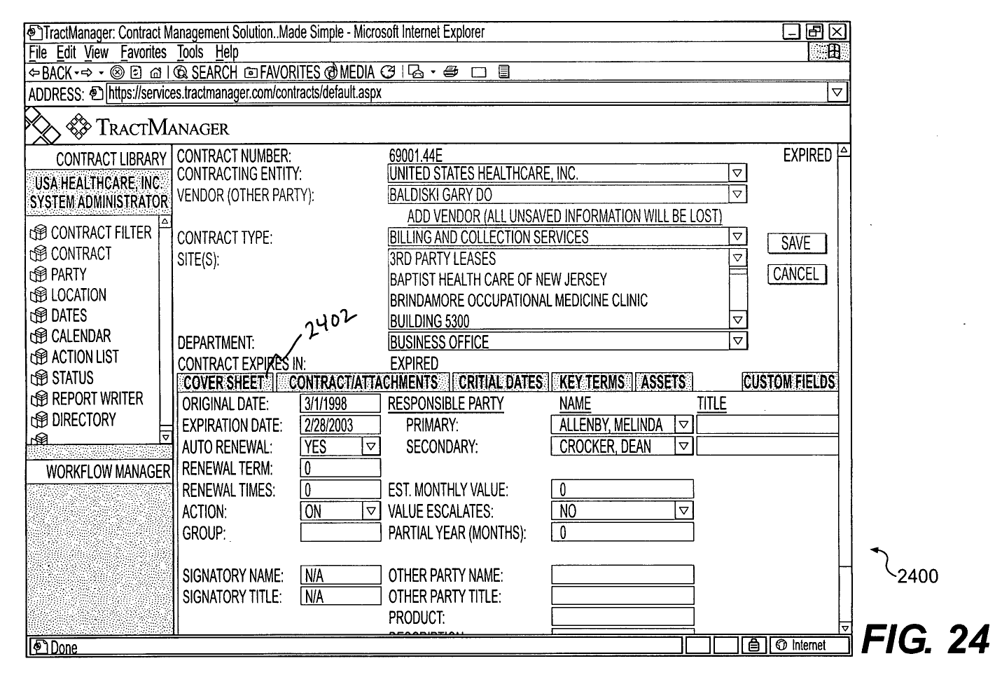

FIG. 24 depicts an exemplary view of a web page according to an embodiment of the present invention. In the FIG. 24 embodiment of the present invention, the “Contract Summary Page” in EDIT mode 2400 allows editors and administrators to ADD and EDIT information contained on the “Contract Summary Page.” The selection of the EDIT option 1014 shown in FIG. 10 navigates a user to the “Contract Summary Page” in EDIT mode 2400. The Contract Summary Page” in EDIT mode 2400 provides all the information that can be edited on a cover sheet. The information may be edited by selecting the appropriate information from a list box or entering text into a text box. The information that can be edited on the cover sheet by selecting the cover sheet tab 2402 of the “Contract Summary Page” in EDIT mode 2400 includes, but is not limited to, contracting entity, vendor (Other Party), contract type, site(s), and department. The selection of the save option, saves the changes to the information.

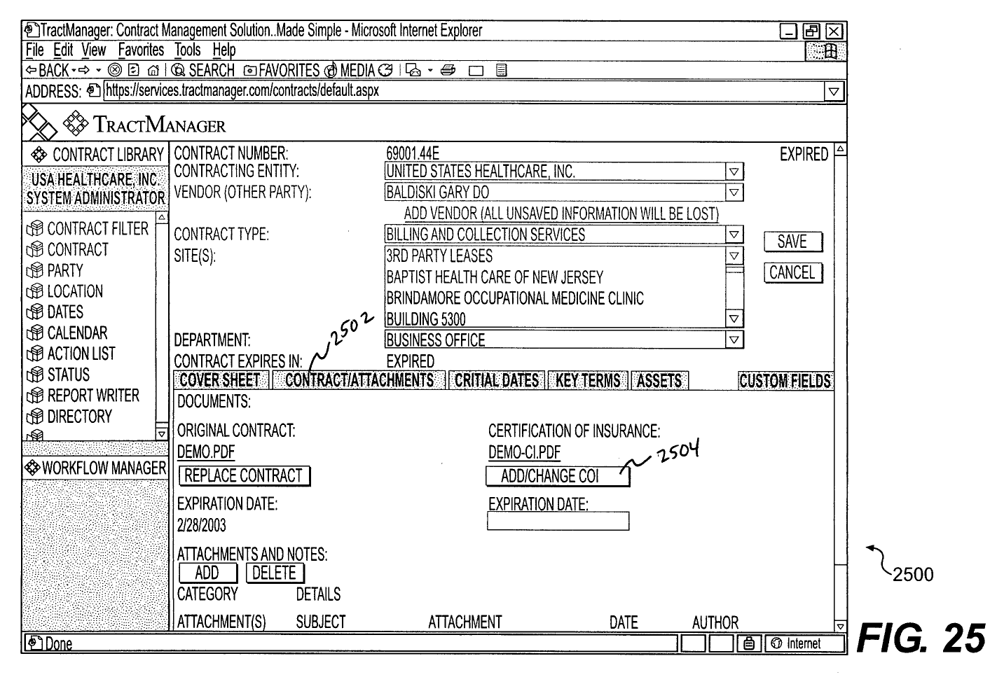

FIG. 25 depicts an exemplary view of a web page according to an embodiment of the present invention. In the FIG. 25 embodiment of the present invention, the “Contract Summary Page” in EDIT mode 2500 allows editors and administrators to ADD and EDIT information contained on the “Contract Summary Page.” The selection of the EDIT option 1014 shown in FIG. 10 navigates a user to the “Contract Summary Page” in EDIT mode 2500. The Contract Summary Page” in EDIT mode 2500 provides all the information that can be edited to contract/attachments. Editing of the information may be performed by either selecting the appropriate information from a list box or by entering text into a text box. The information that can be edited on the contract/attachments by selecting the contract/attachments tab 2502 of the “Contract Summary Page” in EDIT mode 2500 includes, but is not limited to, contracting entity, vendor (Other Party), contract type, site(s), department, the location of the Certificate of Insurance, and the expiration date of the contract for which the contract summary page in EDIT mode is displayed. Users may also change the original contract, and the Certificate of Insurance in accordance with access privileges. To modify the original contract, and the Certificate of Insurance select the ADD COI option 2504 under the current Certificate of Insurance, the browse option 2408, and a specific folder where the item is stored. The SAVE option saves the new COI.

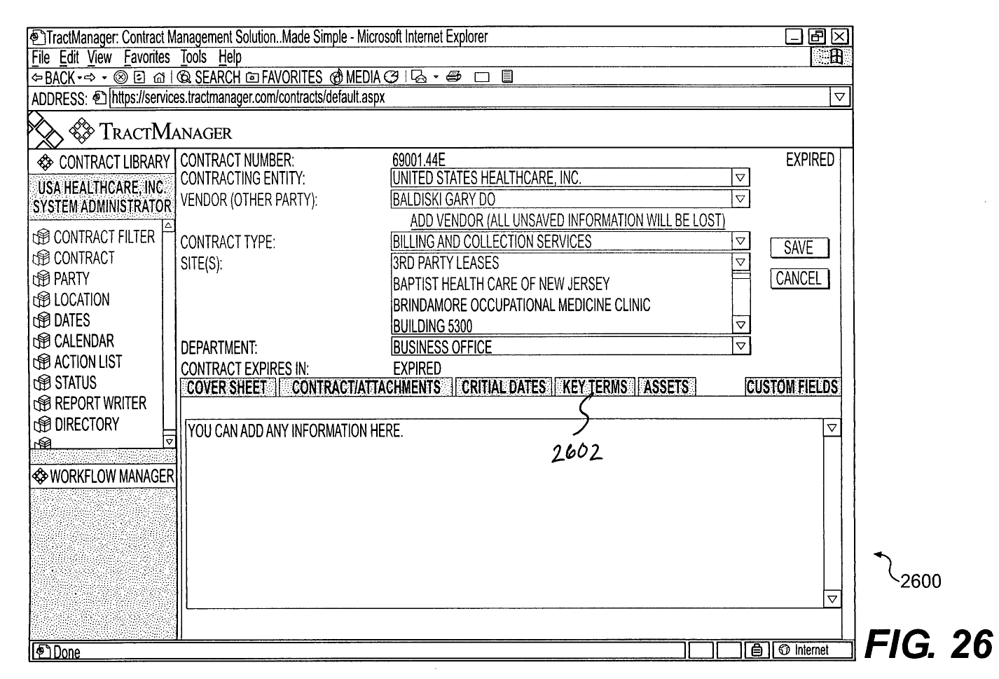

FIG. 26 depicts an exemplary view of a web page according to an embodiment of the present invention. In the FIG. 26 embodiment of the present invention, the “Contract Summary Page” in EDIT mode 2600 allows editors and administrators to ADD and EDIT information contained on the “Contract Summary Page”. The selection of the EDIT option 1014 shown in FIG. 10 navigates a user to the “Contract Summary Page” in EDIT mode. The “Contract Summary Page” in EDIT mode 2600 provides all the key terms information that can be edited. Editing of the information may be performed by either selecting the appropriate information from a list box, or by entering text into a text box. The information that can be edited by selecting the key terms tab 2602 of the “Contract Summary Page” in EDIT mode 2600 includes, but is not limited to, contracting entity, vendor (Other Party), contract type, site(s), department, the key terms for which the contract summary page in EDIT mode is displayed.

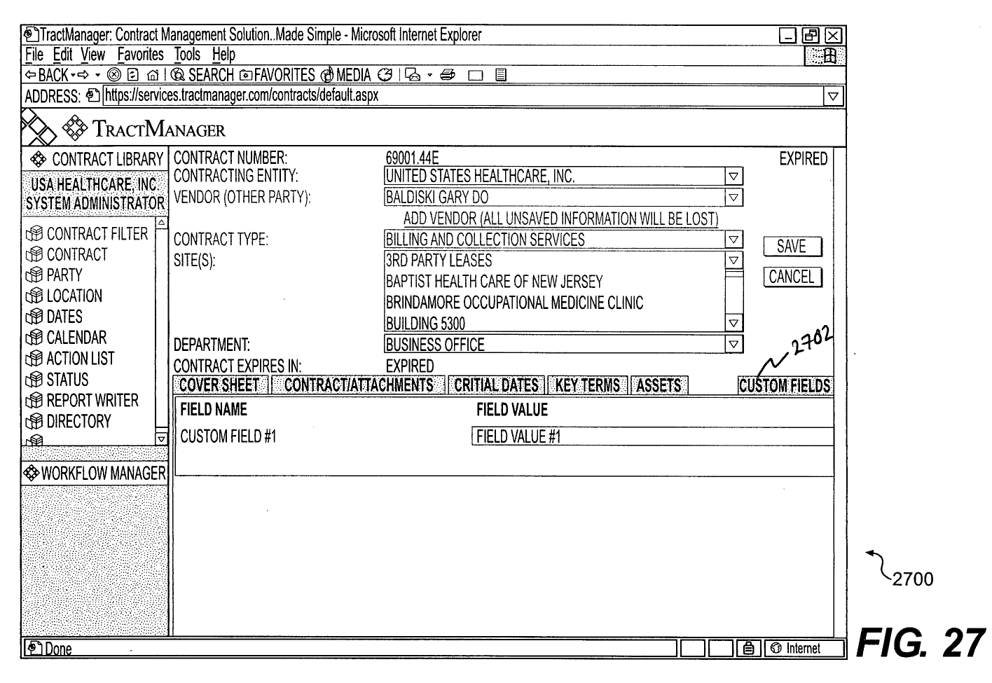

FIG. 27 depicts an exemplary view of a web page according to an embodiment of the present invention. In the FIG. 27 embodiment of the present invention, the “Contract Summary Page” in EDIT mode 2700 allows editors and administrators to ADD and EDIT information contained on the “Contract Summary Page.” The selection of the EDIT option 1014 shown in FIG. 10 navigates a user to the “Contract Summary Page” in EDIT mode. The “Contract Summary Page” in EDIT mode 2700 provides all the information that can be edited for custom fields. Editing of the information may be performed by either selecting the appropriate information from a list box, or by entering text into a text box. The information that can be edited by selecting the custom fields tab 2702 of the “Contract Summary Page” in EDIT mode 2700 are the custom fields for the contract displayed.

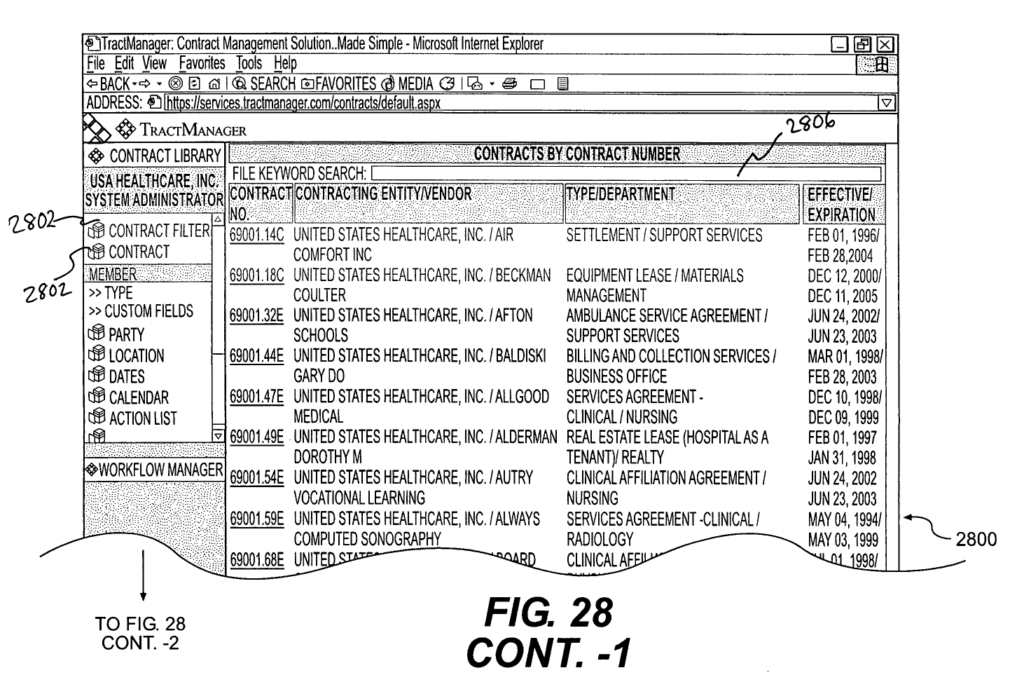

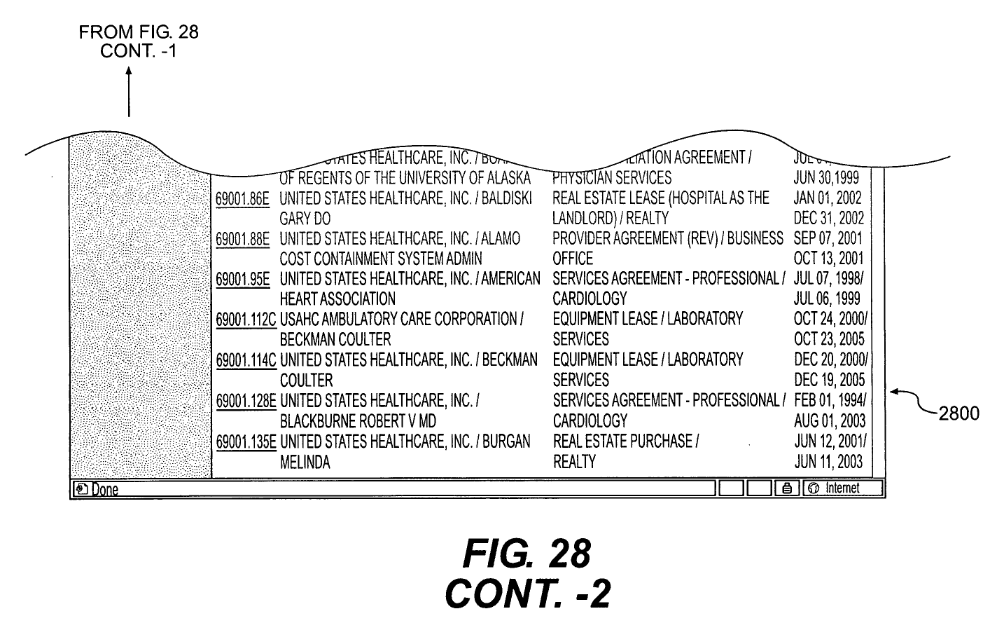

FIG. 28 depicts an exemplary web page that is provided upon selection of the contract library icon 602 shown in FIG. 6. In the FIG. 28 embodiment of the present invention, the selection of the contract icon 2802 from the navigation panel 2804 provides the contract web page 2800. The contract web page 2800 provides different ways to view the contracts in a database. The methods of viewing contracts include, but are not limited to, contract number, contract type, and custom type. In the FIG. 28 embodiment, the contract web page 2800 provides a listing of all contracts a user has access to by contract number. The contract web page 2800 show every contract the user may access. A file keyword search field 2806 allows a keyword search of contract stored in the database. The results of the search will be limited to contracts that the user is authorized to access and includes the keyword. The number of results displayed may be limited by to a specified number.

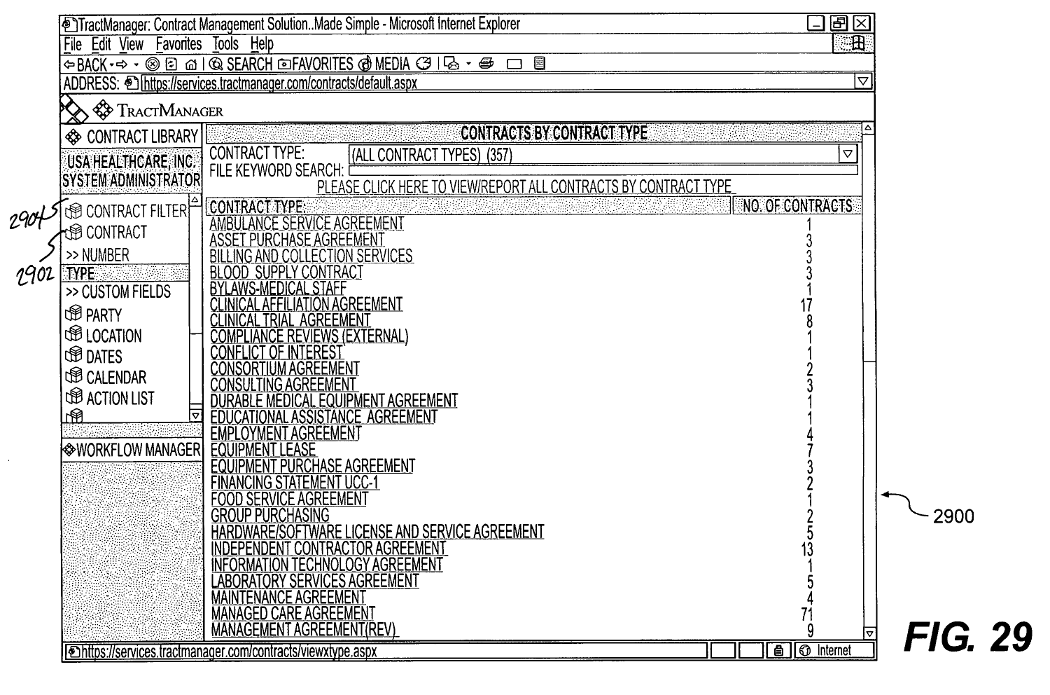

FIG. 29 depicts an exemplary web page that is provided upon selection of the contract library icon 602 shown in FIG. 6. In the FIG. 29 embodiment of the present invention, the selection of the contract icon 2902 from the navigation panel 2904 provides the contract web page 2900. In the FIG. 29 embodiment, the contract web page 2900 provides a listing of all contract types. A contract type list box allows a user to specify the type of contracts to be listed for selection.

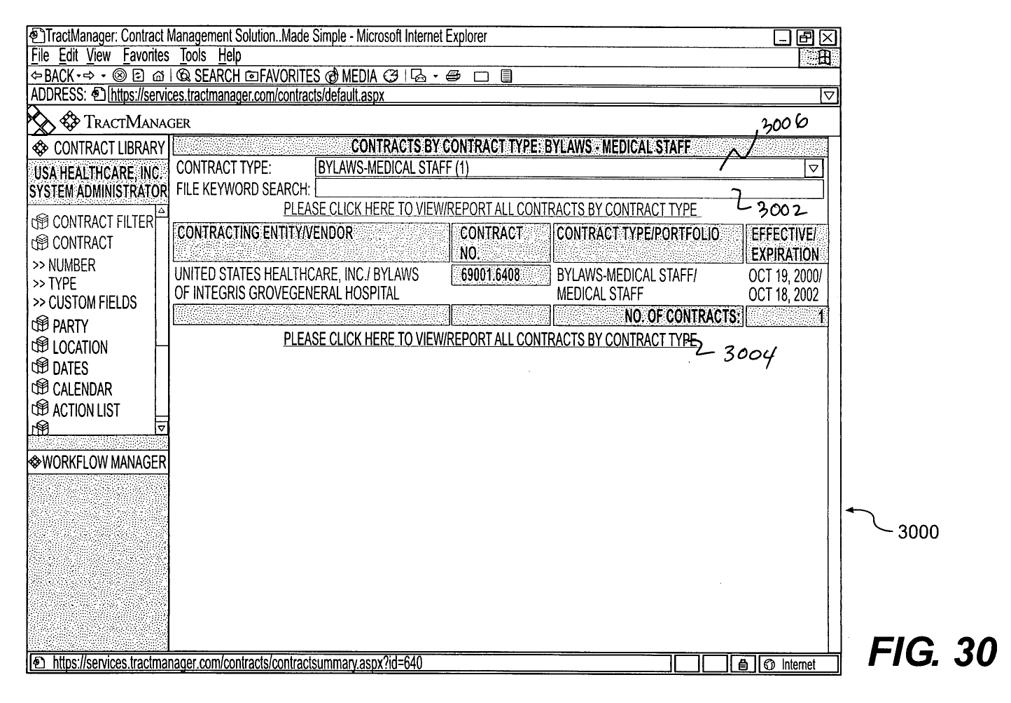

FIG. 30 depicts an exemplary web page that is provided upon selection of the contract type shown in FIG. 29. In the FIG. 30 embodiment of the present invention, contracts of the type selected in FIG. 29 are displayed in contract type web page 3000. The contract type web page 3000 includes a file keyword search field 3002, a view/report link 3004 and a contract type drop down box 3006. The selection of a contract type from the drop down box 3006 allows the user to specify a contract sub-type in accordance with the specific item that was selected from the drop down box. The entry of a keyword in the file keyword search text box 3002 allows a keyword search of contracts stored in the database of the type specified.

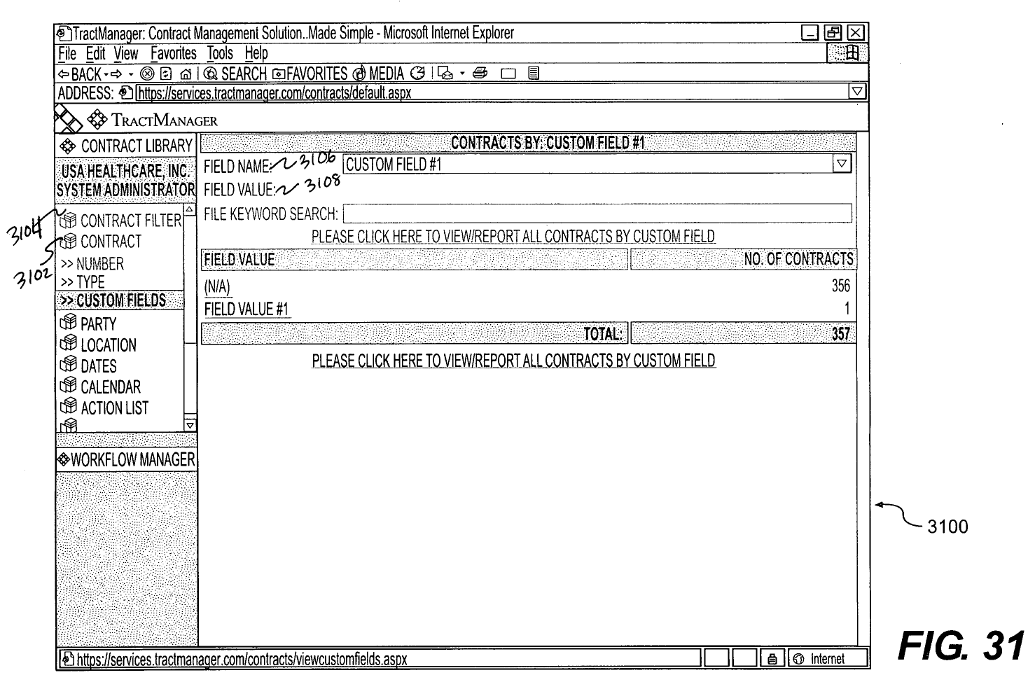

FIG. 31 depicts an exemplary web page that is provided upon selection of the contract library icon 602 shown in FIG. 6. In the FIG. 31 embodiment of the present invention, the selection of the contract icon 3102 from the navigation panel 3104 provides the contract web page 3100. In the FIG. 31 embodiment, the contract web page 3100 provides a listing of the different contracts that are associated with a custom field name 3106 and custom field value 3108 as defined by custom fields for each contract.

Additional methods of viewing contracts include, but are not limited to, those specified in the following table.

| | LOCATION IN | |
|---|---|---|
| | NAVIGATION | |
| VEIWS | PANEL | FEATURES |
| Signatory | PARTY | Displays the Signatory Name |
| | Signatory | table that lists all of the |
| | | contracts associated with |
| | | each Signatory Name, in |
| | | order to search by Signatory |
| | | Name. |
| Other Signatory | PARTY | Displays the Other Signatory |
| | Other Signatory | table that lists all of the |
| | | contracts associated with |
| | | each Other Signatory, in |
| | | order to search by Other |
| | | Signatory. |
| Responsible | PARTY | Displays the Responsible |
| | Responsible | Party table that lists all of the |
| | | contracts associated with |
| | | each Responsible Party, in |
| | | order to search by |
| | | Responsible Party. |
| Vendor (Other | PARTY | Displays the Vendor (Other |
| Party) | Vendor | Party) table that lists all of |
| | (Other Party) | the contracts associated with |
| | | each Vendor (Other Party), |
| | | in order to search by Vendor |
| | | (Other Party). |
| Contracting Entity | LOCATION | Displays the Contracting |
| | Contracting Entity | Entity table that lists all of |
| | | the contracts associated with |
| | | each Contracting Entity, in |
| | | order to search by |
| | | Contracting Entity. |
| Site | LOCATION | Displays the Contract Site |
| | Site | table that lists all of the |
| | | contracts associated with |
| | | each Contract Site, in order |
| | | to search b Contract Site. |
| Department | LOCATION | Displays the Department |
| | Department | table that lists all of the |
| | | contracts associated with |
| | | each Department, in order to |
| | | search by Department. |
| Group | LOCATION | Displays the Group table that |
| | Group | lists all of the contracts |
| | | associated with each Group, |
| | | in order to search b Group. |
| Effective Date | DATES | Displays the Effective Date |
| | Effective Date | table that lists all of the |
| | | contracts by Effective Date. |
| | | This page allows the user to |
| | | search their databases by the |
| | | original execution date of a |
| | | contract. |
| Expiration Date, | DATES | Displays the Expiration Date |
| Contract | Expiration Date, | table that lists all of the |
| | Contract | certificates by Expiration |
| | | Date. This page allows the |
| | | user to search their databases |
| | | by the Expiration Date of a |
| | | contract. |
| Expiration Date, | DATES | Displays the Expiration |
| Certificate | Expiration Date, | Date table that lists all of |
| | Certificate | the certificates by |
| | | Expiration Date. This page |
| | | allows the user to search |
| | | their databases by the |
| | | expiration date of a |
| | | certificate. |
| Auto Renewal | DATES | Displays the Auto Renewal |
| | Auto Renewal | Date table that lists all of the |
| | | contracts having an |
| | | Automatic Renewal |
| | | provision. This page allows |
| | | the user to search their |
| | | databases by the auto |
| | | renewal status of a contract. |
| Critical Dates | DATES | Displays the Critical Dates |
| | Critical Date | table that lists all of the |
| | | contracts having a Critical |
| | | Date. This page allows the |
| | | user to search their databases |
| | | b the Critical Date of a |
| | | contract. |
| Effective Date, | CALENDAR | This page provides the user |
| Contract | Effective Date, | with a calendar depicting the |
| (Calendar) | Contract | Effective Dates of the |
| | | contracts. Contracts within |
| | | these views can be filtered |
| | | further by selecting an item |
| | | in the drop down list that you |
| | | wish to view the contracts |
| | | by. (Ex. Type, Site, Vendor |
| | | Other Party).) |
| Expiration Date, | CALENDAR | Similar to the Effective Date, |
| Contract | Expiration Date, | Contract view. Shows all |
| (Calendar) | Contract | contracts by Expiration Date |
| | | in relationship to their |
| | | corresponding calendar date. |
| Expiration Date, | CALENDAR | Displays the Expiration |
| Certificate | Expiration Date, | Dates of the contracts, by |
| (Calendar) | Certificate | calendar date. |
| Critical Date | CALENDAR | Displays the Critical Dates |
| (Calendar) | Critical Date | calendar view that lists all of |
| | | the contracts having a |
| | | Critical Date. |
| Action List | ACTION LIST | Displays the Action List |
| | | view that lists all contracts |
| | | that have expired since the |
| | | activation of your database. |
| | | These agreements require |
| | | some action to remove them |
| | | from this list Renew Archive |
| | | or Delete). |
| All (Status) | STATUS | The Status search will give a |
| | All | user access to the active, |
| | | expired and archived contract |
| | | files within their database. |
| | | This view shows you the |
| | | contracts for each status. |
| Active Only | STATUS | Displays the Active contracts |
| | Active Only | within the database. |
| Expired Only | STATUS | Displays the contracts that |
| | Expired Only | are Expired within the |
| | | database. |
| Archived Only | STATUS | Displays the contracts that |
| | Archived Only | are Archived within the |
| | | database. Contracts are |
| | | listed in chronological |
| | | order, and this is the only |
| | | place where Archived |
| | | contracts are listed. |
| No Monthly Value | STATUS | Displays the contracts that |
| | No Monthly Value | have No Monthly Value. |
| | | These contracts have not |
| | | had the Average Monthly |
| | | Value field populated on the |
| | | “Contract Summary Page”. |
| | | To ADD this information, |
| | | go to the “Contract |
| | | Summary Page” and EDIT |
| | | the page, ADDing the |
| | | appropriate value into the |
| | | Average Monthly_Values |
| | | field. |
| Business | COMPLIANCE | This view shows you the |
| Associate | Business Associate | status and information for |
| (Compliance) | | all of your Business |
| | | (Compliance) Associate |
| | | Agreements (according to |
| | | the appropriate response |
| | | given for each contract) by |
| | | information that was |
| | | inputted on the Compliance |
| | | tab. You can go directly to |
| | | each contract by clicking on |
| | | the hyperlink for each |
| | | contract number. |
| Trade Partnership | COMPLIANCE | Displays all contracts |
| (Compliance) | Trade Partnership | relating to Trade |
| | | Partnership Agreements. |
| Conflict of | COMPLIANCE | Displays all contracts |
| Interest | Conflict of Interest | relating to Conflict of |
| (Compliance) | | Interest Statements. |

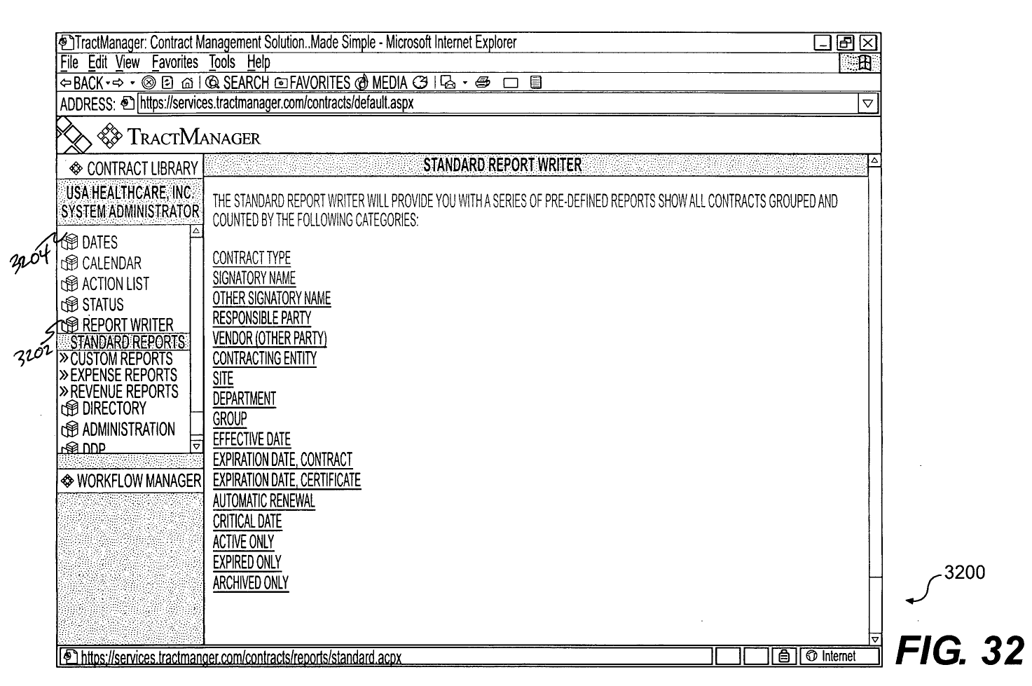

FIG. 32 depicts an exemplary web page that is provided upon selection of the contract library icon 602 shown in FIG. 6. In the FIG. 32 embodiment of the present invention, the selection of the report writer icon 3202 from the navigation panel 3204 provides the report writer web page 3200. The standard report writer web page 3200 provides categories of pre-defined reports. The categories include, but are not limited to, contract type, signatory name, other signatory name, responsible party, vendor, contracting entity, site, department, group, effective date of contract, expiration date of contract, expiration date of certificate, automatic renewal, critical date, active only, expired only, and archived only. The selection of a category generates a report that will be populated in accordance with the category in a printer friendly version.

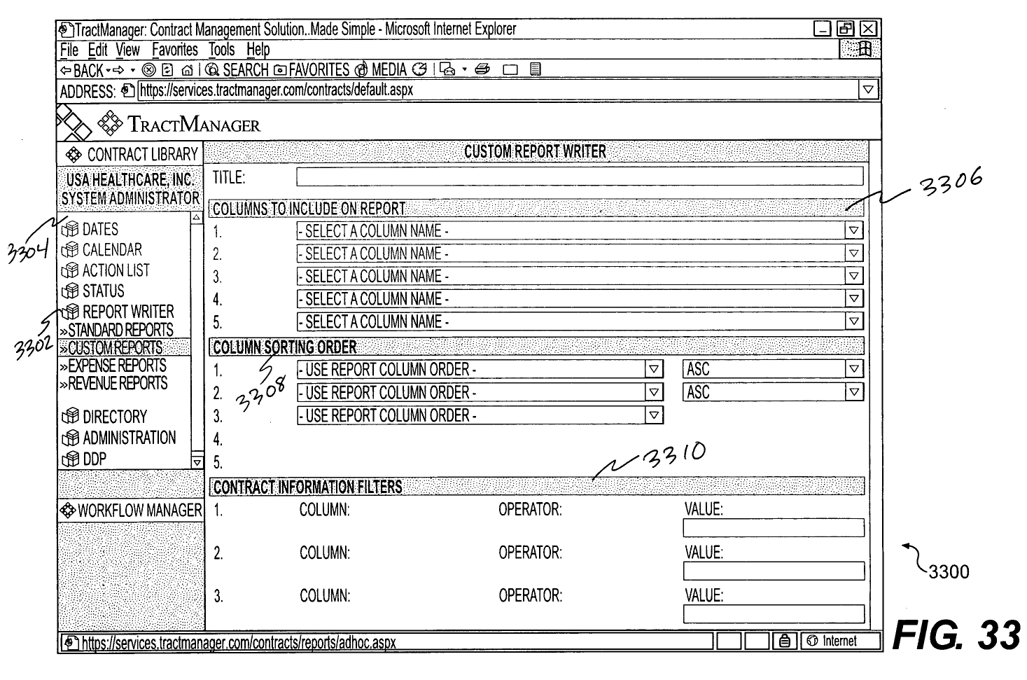

FIG. 33 depicts an exemplary web page that is provided upon selection of the contract library icon 602 shown in FIG. 6. In the FIG. 33 embodiment of the present invention, the selection of the report writer icon 3302 from the navigation panel 3304 provides the custom report writer web page 3300. The custom report writer web page 3300 enables a user to create custom reports detailing specific database information. The custom report writer web page 3300 allows a user to select specific information to report. In the FIG. 33 embodiment of the present invention, options are provided including, but not limited to, title 3304, columns to include 3306, column sorting order 3308 and contract information filters 3310. The Title textbox 3304 allows the title of a report to be specified. The columns to include on report option 3306 allows the selection of data desired in the report. The columns sorting order option 3308 allows sorting of the data in the manner desired for each column. The contract information filter option 3310 allows the specification of specific information that users wish to report for each section of information. The contract information filter section may be used to filter the information that is returned under each column. The run report option 3312 may be selected to generate the report.

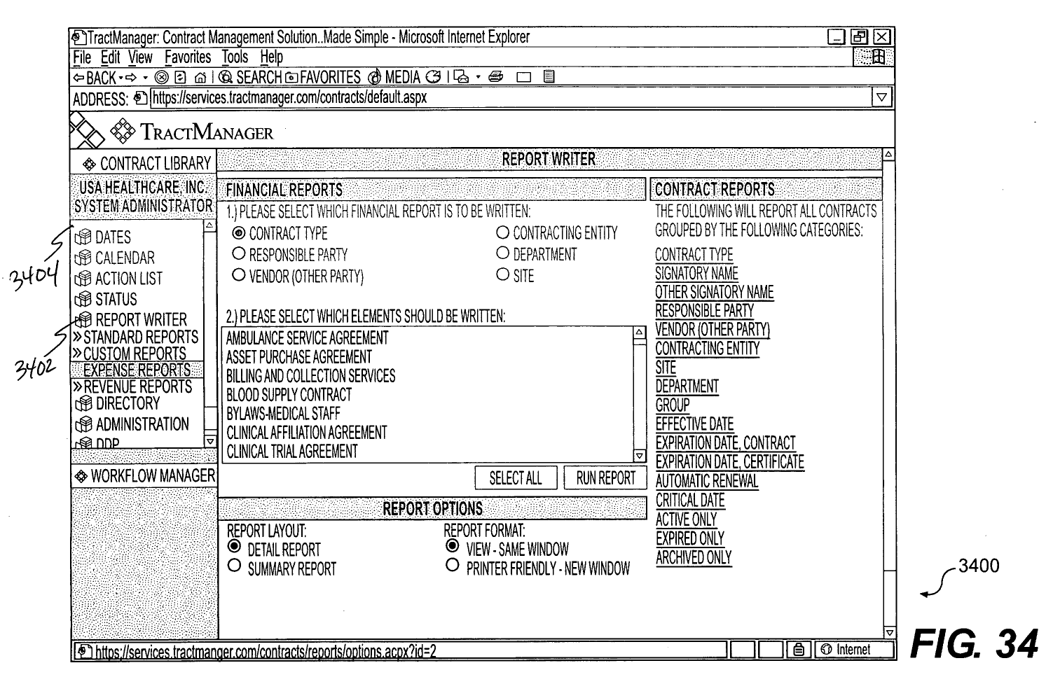

FIG. 34 depicts an exemplary web page that is provided upon selection of the contract library icon 602 shown in FIG. 6. In the FIG. 34 embodiment of the present invention, the selection of the report writer icon 3402 from the navigation panel 3404 provides the expense financial report writer web page 3400. The expense financial report writer web page 3400 enables a user to create financial reports detailing specific database information about expenses. The expense financial report writer web page 3400 allows a user to select specific financial information to report. In the FIG. 34 embodiment of the present invention, financial report options are provided including, but not limited to category 3404, elements to include 3406, and report layout 3410. The run report option 3412 may be selected to generate the report.

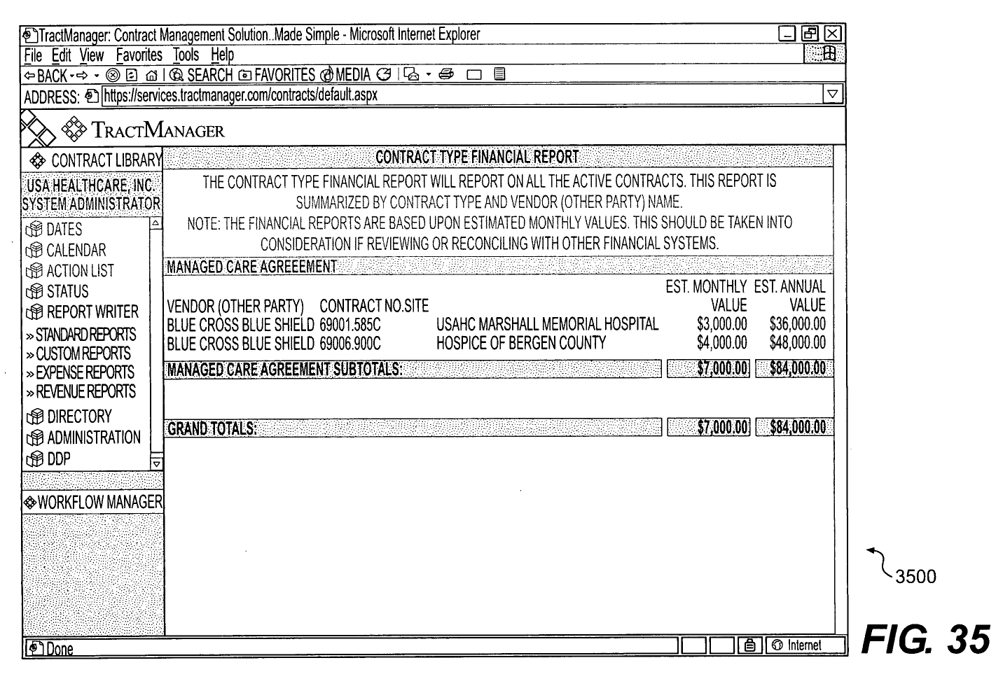

FIG. 35 depicts an exemplary web page that is provided upon running a report using the financial reports options shown in FIG. 34. In the FIG. 35 embodiment of the present invention, the financial report page 3500 provide information base on contract type and vendor type categories in a detailed format.

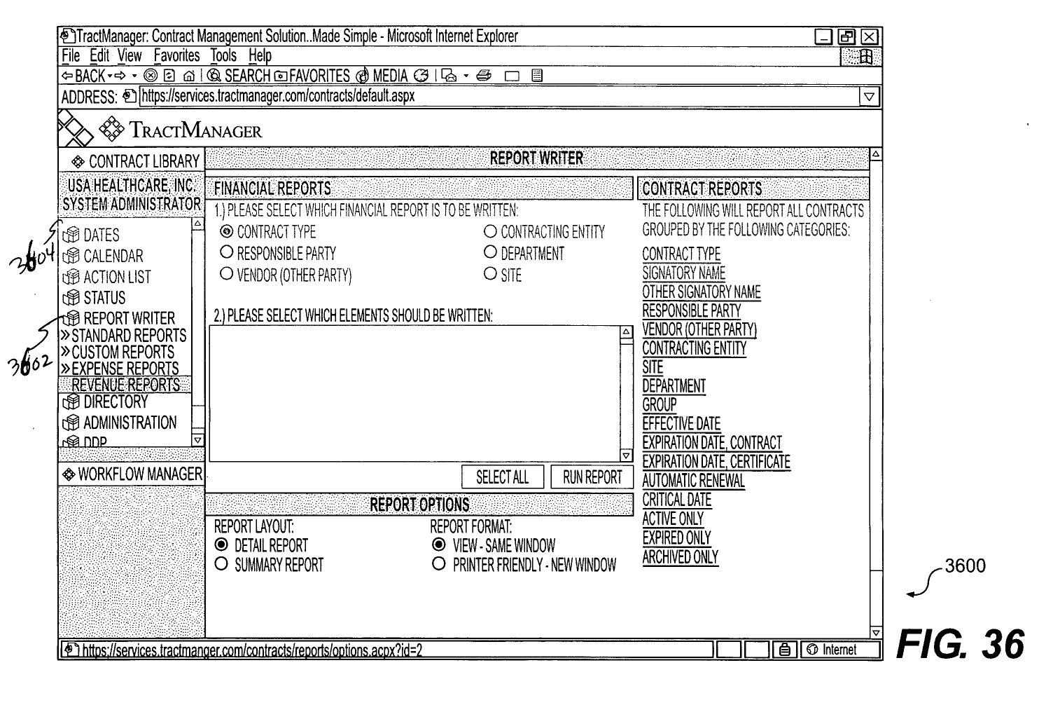

FIG. 36 depicts an exemplary web page that is provided upon selection of the contract library icon 602 shown in FIG. 6. In the FIG. 36 embodiment of the present invention, the selection of the report writer icon 3602 from the navigation panel 3604 provides the revenue financial report writer web page 3600. The revenue financial report writer web page 3600 enables a user to create financial reports detailing specific database information about revenue. The revenue financial report writer web page 3600 allows a user to select specific financial information to report. In the FIG. 36 embodiment of the present invention, financial report options are provided including, but not limited to, a category 3604, elements to include 3606, and report layout 3610. The run report option 3612 may be selected to generate the report.

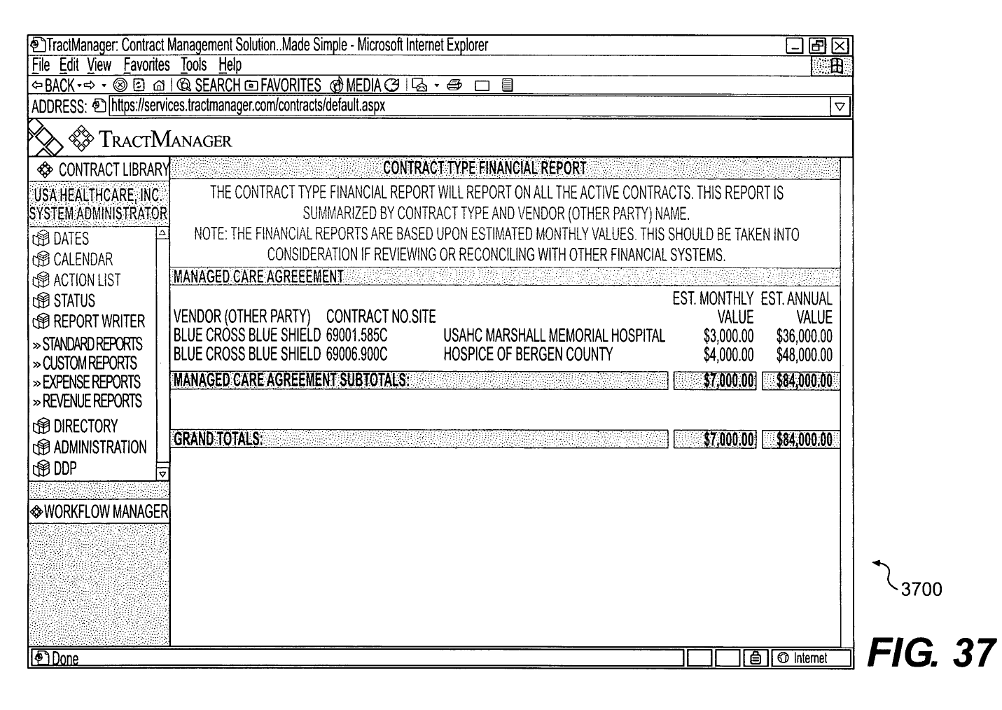

FIG. 37 depicts an exemplary web page that is provided upon running a report using the financial reports options shown in FIG. 36. In the FIG. 37 embodiment of the present invention, the financial report page 3700 provide information base on contract type and vendor type categories in a summary format.

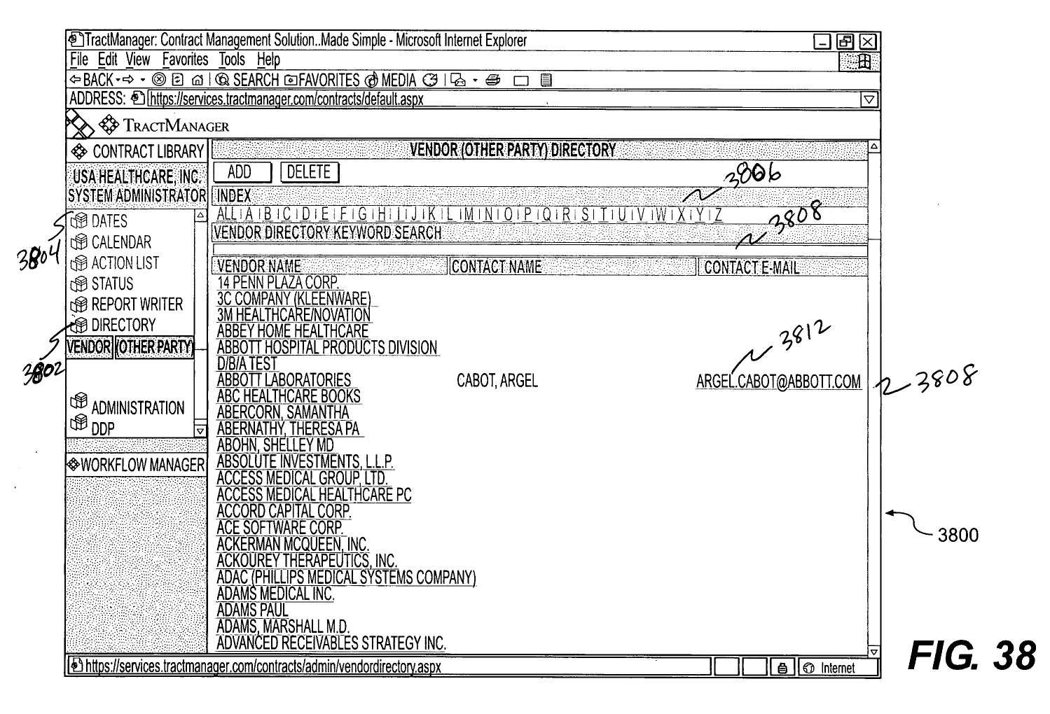

FIG. 38 depicts an exemplary web page that is provided upon selection of the contract library icon 602 shown in FIG. 6. In the FIG. 38 embodiment of the present invention, the selection of the directory icon 3802 from the navigation panel 3804 provides a vendor directory web page 3800. The vendor directory web page 3800 provides an alphabetical listing of vendors associated with contracts stored in the database. A scroll bar 3808 provides for scrolling of the list. A list of page numbers 3810 are provided to navigate a user to ADDitional segments of a vendor list. Contact email(s) options 3812 are provided for each vendor on the vendor list. Contact email(s) option 3812 enable the transmission of e-mails to the specified contact for that vendor. The selection of a listed vendor provides a profile associated with the vendor in accordance with access privileges of users. The vendor directory web page 3800 provides navigation options for listing vendors. The navigation options include, but are not limited to, an alphabetical listing 3804 and keyword search field 3806. Each letter of the alphabetical listing 3804 navigates a user to a web page listing all vendors beginning with that letter. The vendor directory keyword search field 3806 enables the generation of a list of vendors associated with a specified keyword.

In the FIG. 38 embodiment of the present invention, vendor profile modification options are provided. The modification options include, but are not limited to, ADD 3814, EDIT 3816, and DELETE 3818. The modification options function as discussed above with respect to similar functions for the contract attachment/note pages, the critical dates pages, and the asset log pages, and thus, will not be discussed again here.

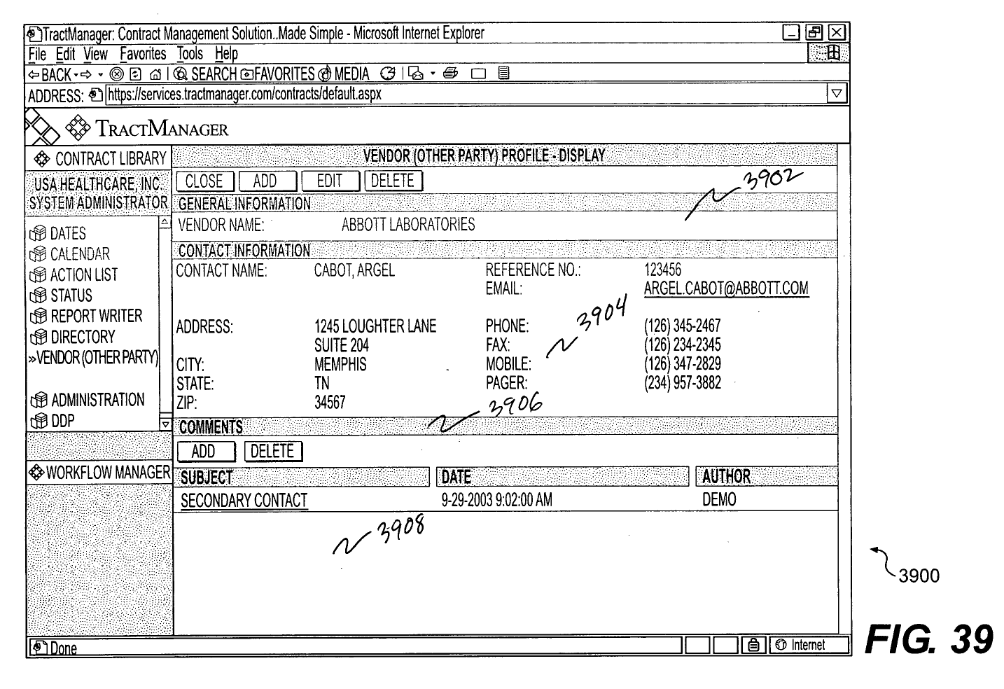

FIG. 39 depicts an exemplary web page that is provided upon the selection of a vendor listed on the vendor directory web page 3800 shown in FIG. 38. In the FIG. 39 embodiment of the present invention, the vendor profile web page 3900 includes a general information section 3902, a contact information section 3904, a comments section 3906, and a subject section 3908. The comments section 3906 includes a comment ADD option 3910, a comment DELETE option 3812 and a comment EDIT option 3914. Users with editor or administrator access privileges may use the comment options to input comments and other information in the comments section of the Vendor Profile. The comment options function as discussed above with respect to similar ADD, DELETE and EDIT options, and thus, will not be discussed again here.

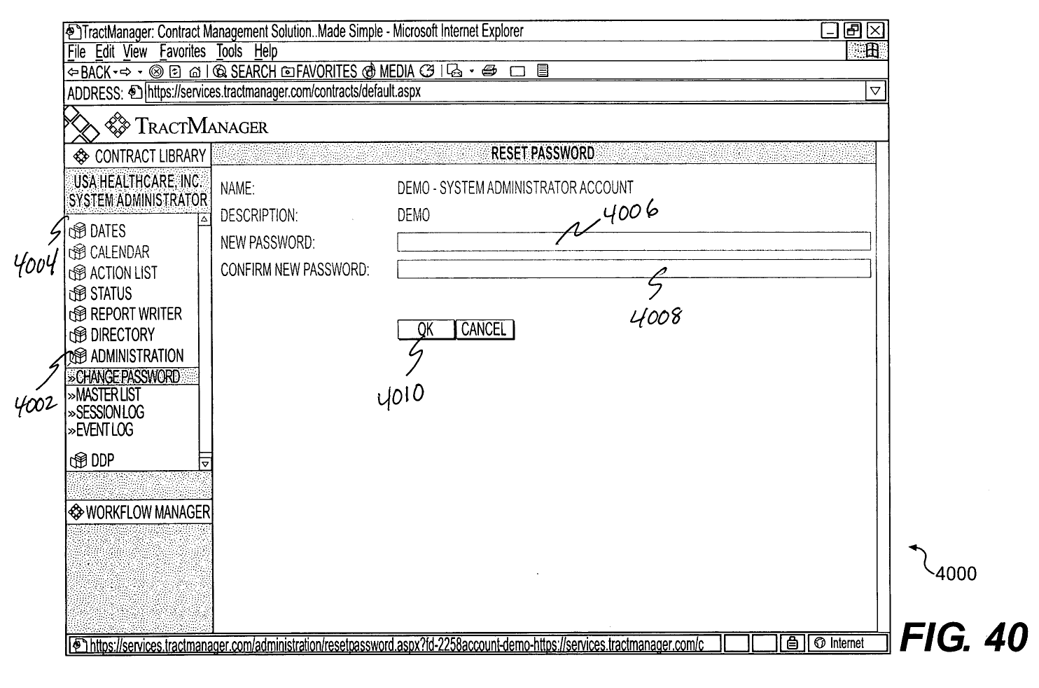

FIG. 40 depicts an exemplary web page that is provided upon selection of the contract library icon 602 shown in FIG. 6. In the FIG. 40 embodiment of the present invention, the selection of the administration icon 4002 from the navigation panel 4004 provides a change password web page 4000. The change password web page 4000 allows users to change their password at any time. Users having system administrator privileges may reset user password using a page similar to change password web page 4000. Password textboxes 4006 and 4008 are provided for entry of a new password. The selection of the OK option 4010 activates the password entered in the password textboxes 4006 and 4008. In the FIG. 40 embodiment of the present invention, passwords are case sensitive.

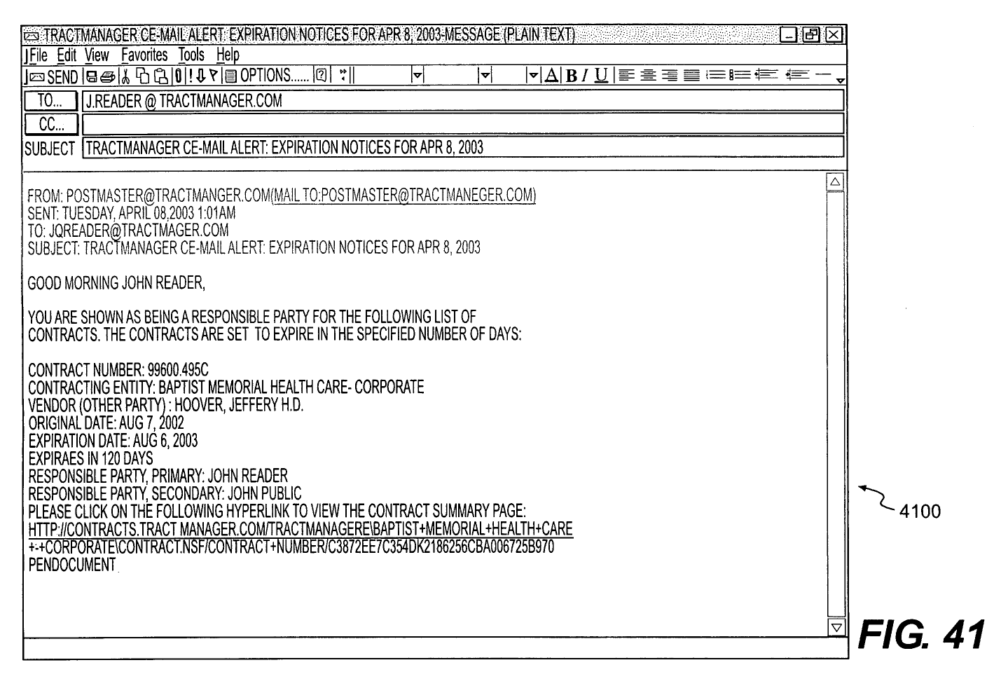

FIG. 41 depicts an exemplary email according to an embodiment of the present invention. In the FIG. 41 embodiment of the present invention, the CE-Mail notice 4100 notifies users of actions needed to be performed with respect to a specific contract. The types CE-Mail notices generated and transmitted include, but are not limited to, expiration date notices, critical date notices, new contract notices, and destruction notices. In the FIG. 41 embodiment of the present invention the CE-Mail notice includes a link to navigate a recipient of the CE-Mail directly to a respective contract in the database. CE-Mail notices are generated and transmitted to respective Parties associated with a contract at intervals prior to a an action date including, but not limited to, 120 days, 90 days, 60 days, 30 days, 14 days, 7 days. After an action date has passed, with no action, the notice will be posted under an action list heading on the navigation panel.

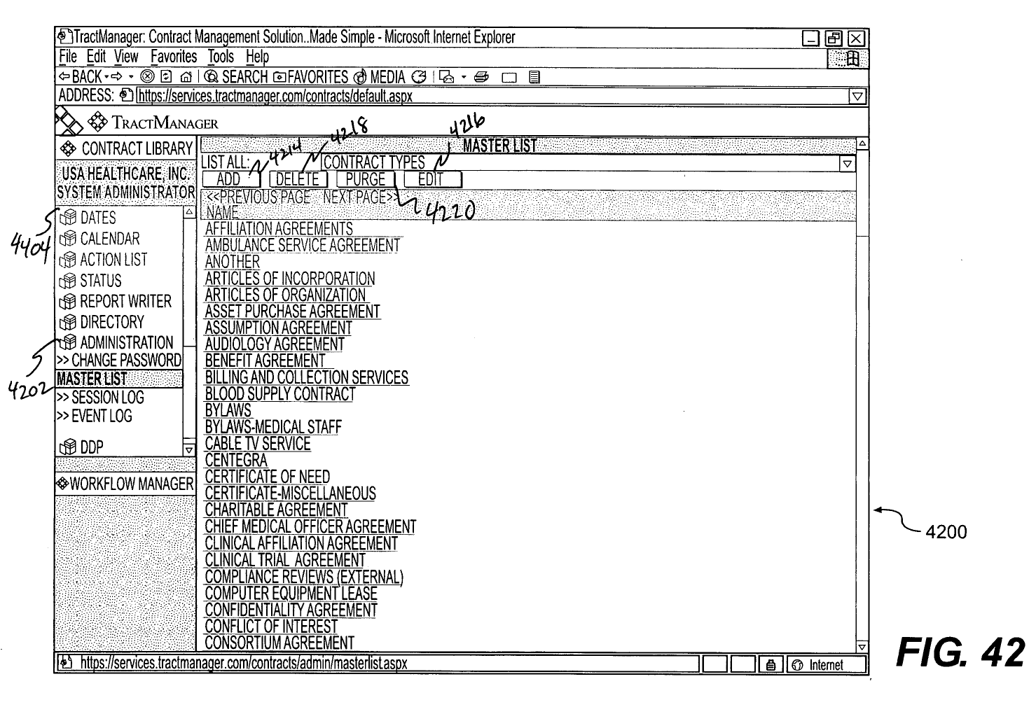

FIG. 42 depicts an exemplary web page that is provided upon selection of the contract library icon 602 shown in FIG. 6. In the FIG. 42 embodiment of the present invention, the selection of the administration icon 4202 from the navigation panel 4204 provides a master list web page 4200. The master list web page 4200 allows users with administrator privileges to maintain a list of contract types and departments associated with an entity. In the FIG. 42 embodiment of the present invention, the master list web page 4200 provides modification options. The modification options include, but are not limited to, ADD 4214, EDIT 4216, and DELETE 4218. The modification options function as discussed above with respect to similar functions for the contract attachment/note pages, the critical dates pages, and the asset log pages, and thus, will not be discussed again here. Users with administrator privileges also have the ability to purge any items that are not used. The PURGE option 4220 scans through the contracts in a database and removes all contract types or departments that are not being used from a master list.

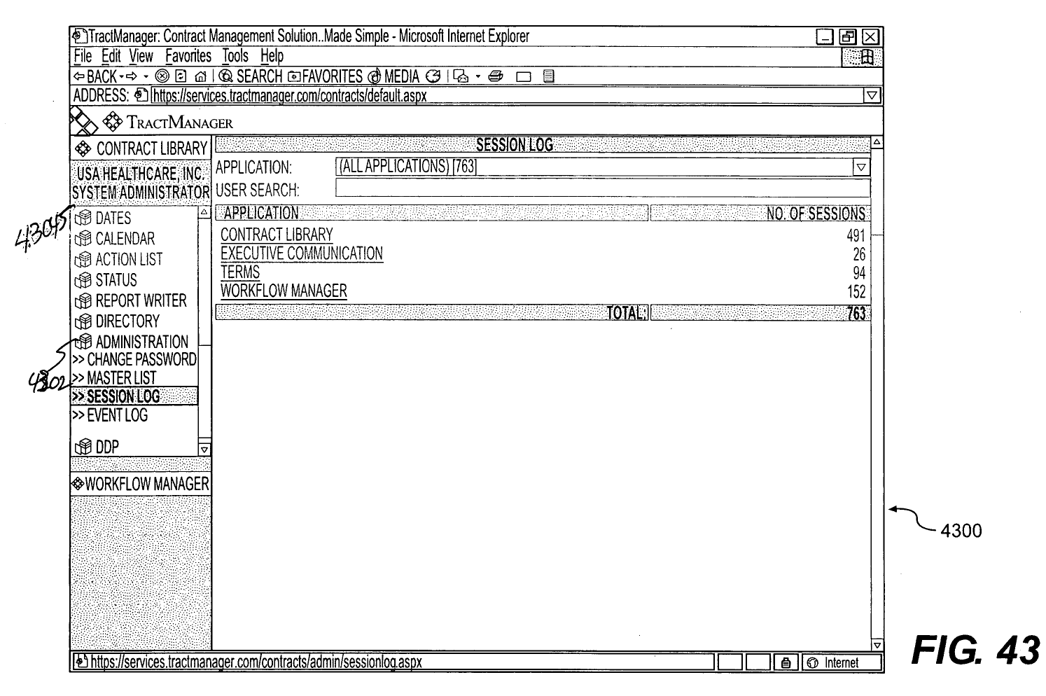

FIG. 43 depicts an exemplary web page that is provided upon selection of the contract library icon 602 shown in FIG. 6. In the FIG. 43 embodiment of the present invention, the selection of the administration icon 4302 from the navigation panel 4304 provides a session log web page 4300. The session log web page 4200 allows users with administrator privileges to track user access to system 102. A user with administrator access privileges selects the application they wish to view to identify users accessing a system 102. The user will be navigated a page that lists usernames as well as the date, and the time that the system 102 was accessed by the users.

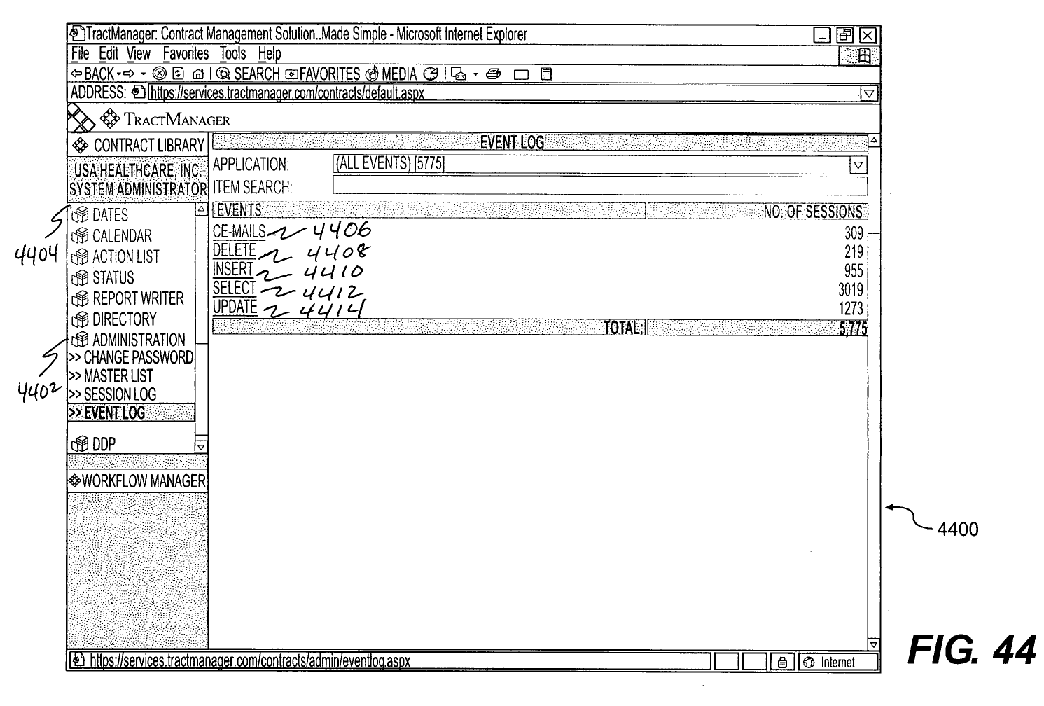

FIG. 44 depicts an exemplary web page that is provided upon selection of the contract library icon 602 shown in FIG. 6. In the FIG. 44 embodiment of the present invention, the selection of the administration icon 4402 from the navigation panel 4404 provides a event log web page 4400. The event log web page 4400 allows users with administrator access privileges to track any data changes with a system 102. A table listing all events is provided along with a running total of the amount of times each action took place to allow tracking of changes with in a system 102. The listing of events includes, but are not limited to, CE-Mail 4406, Delete 4408, Insert 4410, Select 4412, and Update 4414. The CE-Mail option 4406 enables information related to CE-mails to be viewed. The Delete 4408 option enables information that has been changed to be viewed. The Insert 4410 option enables information that has been inserted to be viewed. The Update 4414 option enables information that has been updated to be viewed.

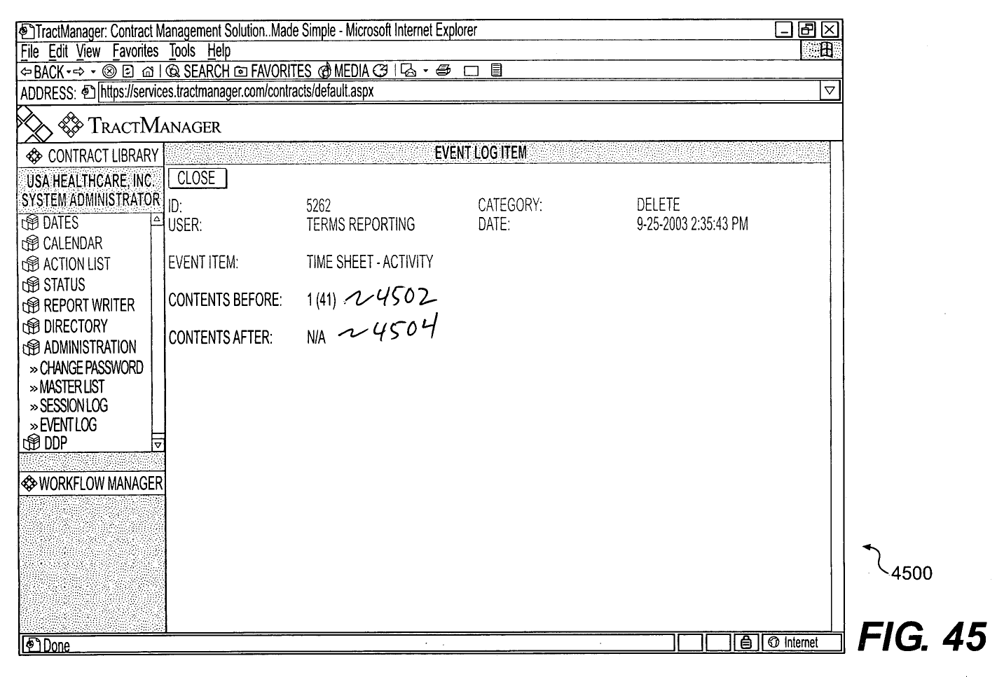

FIG. 45 depicts an exemplary web page that is provided upon selection of the Delete 4408 option shown in FIG. 44. In the FIG. 45 embodiment of the present invention, the event log web page 4500 provides information about an event that took place in a system 102. The event log web page 4500 includes a contents before section 4502 and contents after section 4504. The contents before section provides information DELETEd from the events log. The Contents After section provides information that replaced the DELETEd information.

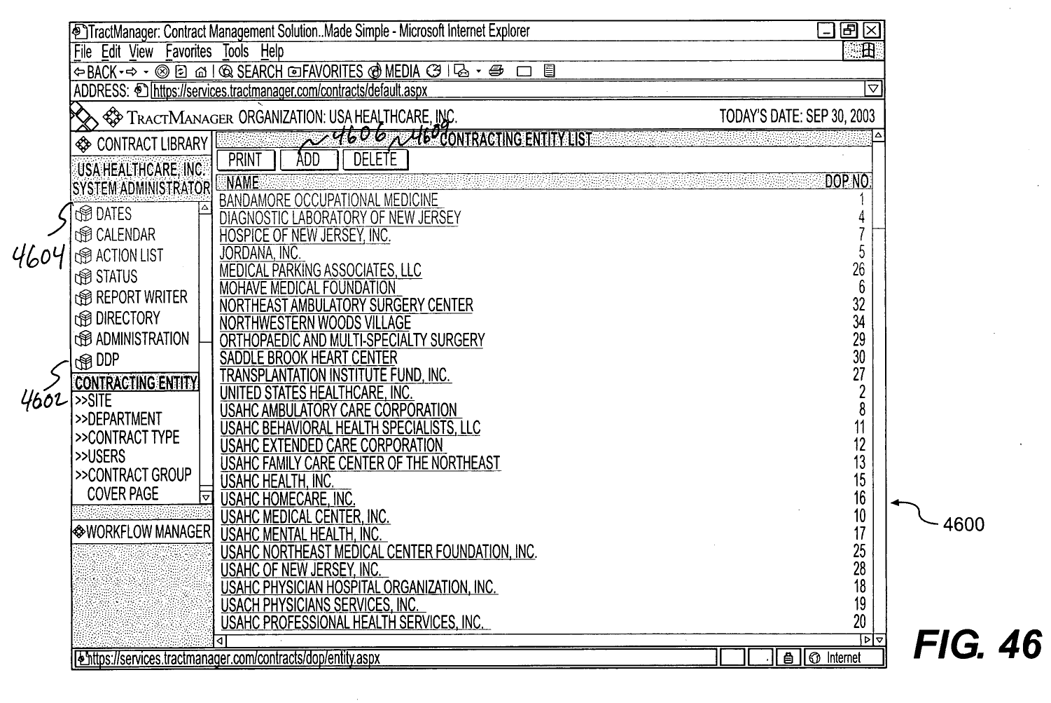

FIG. 46 depicts an exemplary web page that is provided upon selection of the contract library icon 602 shown in FIG. 6. In the FIG. 46 embodiment of the present invention, the selection of the data organization packet (DOP) icon 4602 from the navigation panel 4604 provides a contract entity list web page 4600. The contract entity list web page 4600 allows users with administrator privileges to store important information relating to categories including, but not limited to, contracting entities, sites, departments, contract types, users, and contract group cover page. These categories are accessible from the navigation panel 4604. The categories assist users with administrator access privileges with the organization of the database. In the FIG. 46 embodiment of the present invention, the contract entity list web page 4600 provides modification options. The modification options include, but are not limited to, ADD 4606, EDIT 4608, and DELETE 4609. The modification options may be applied to each of the categories in a manner discussed above with respect to similar functions for the contract attachment/note pages, the critical dates pages, and the asset log pages, etc., and thus, will not be discussed again here.

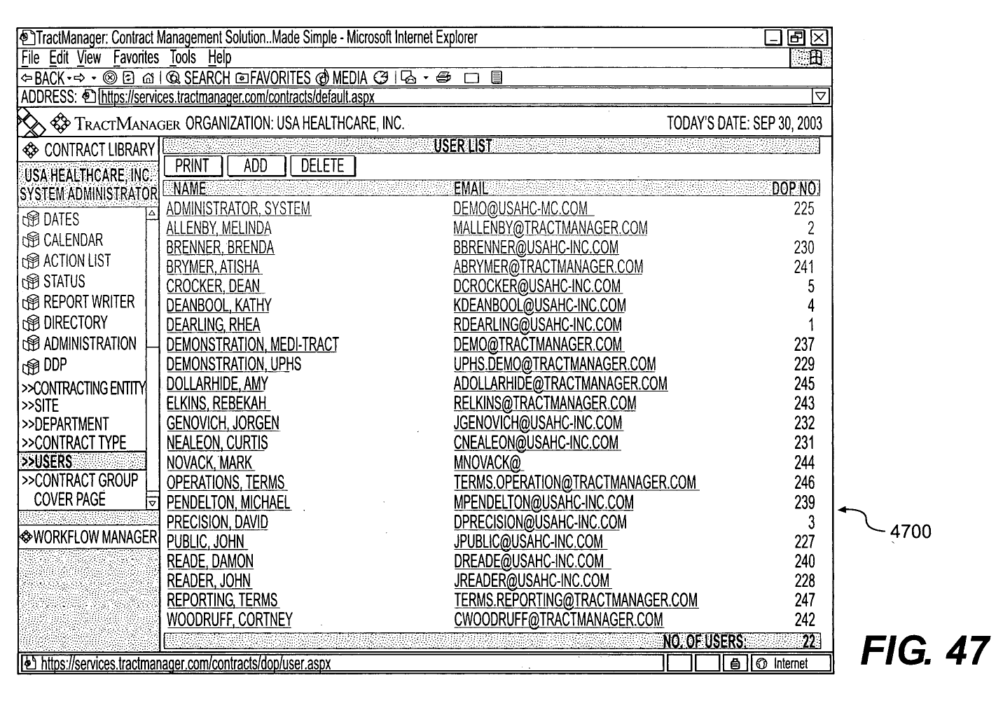

FIG. 47 depicts an exemplary web page that is provided upon selection of the user category shown in FIG. 46. In the FIG. 47 embodiment of the present invention, the user list web page 4700 provides a listing of users of system 102. The user list web page includes, a columns of user names, and a column of email ADDresses for each of the respective users in the column of user names. The selection of an email ADDress enable an email to be prepared and transmitted. The user list web page 4700 provides access to the user profiles for all of the users listed.

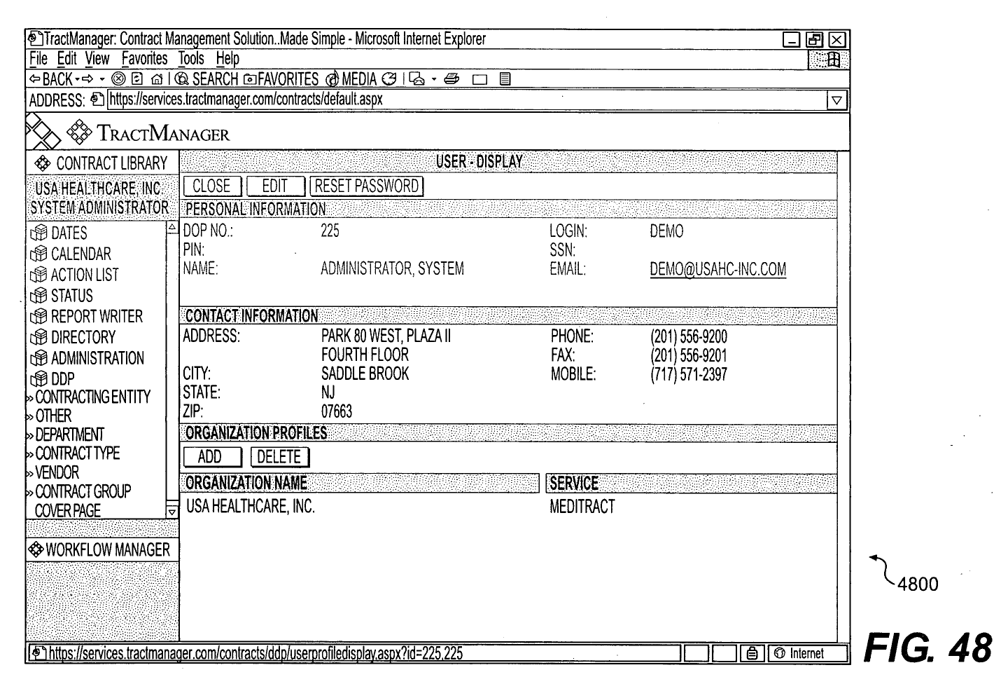

FIG. 48 depicts an exemplary web page that is provided upon selection of user name from the user list web page 4700 shown in FIG. 47. In the FIG. 48 embodiment of the present invention, the user profile web page 4800 allows users having administrator access privileges to perform actions on information related to the user profile. The user profile web page 4800 includes sections of information relevant to a specific user. The different sections of information include, but are not limited to, a personal information section 4802 a contact information section 4804 and a user profile section 4806. The personal information section includes the selected user's name, login name 4808, email ADDress 4810, and other information. The Contact Information section 4804 includes ADDress 4812, phone number 4814 and Fax information 4816. The user profile section 4806 includes the entity the user is tied to 4818, the user's roles 4820 for each specific application of system 102, and the user's privileges (Contracting Entity, Site, Department, Type). Users having Administrator access privileges are able to change permissions and the user's access to certain applications. Users having system administrators access privileges can reset passwords in the DOP for Users. In the FIG. 48 embodiment of the present invention, the user profile web page 4800 provides modification options. The modification options include, but are not limited to, ADD 4824, EDIT 4826, and DELETE 4828. The modification options may be applied to each of the categories in a manner discussed above with respect to similar functions for the contract attachment/note pages, the critical dates pages, and the asset log pages, etc., and thus, will not be discussed again here.

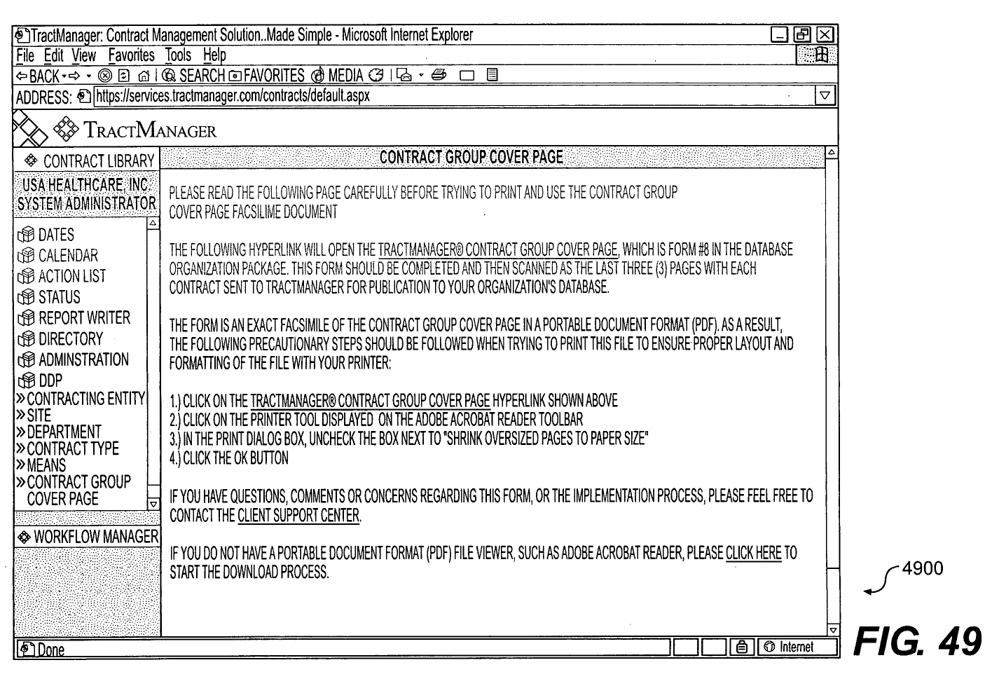

FIG. 49 depicts an exemplary web page that is provided upon selection of the user category shown in FIG. 46. In the FIG. 49 embodiment of the present invention, the contract group cover web page 4900 provides an explanation of the steps needed in order to accurately print, fill out, and send any documents.

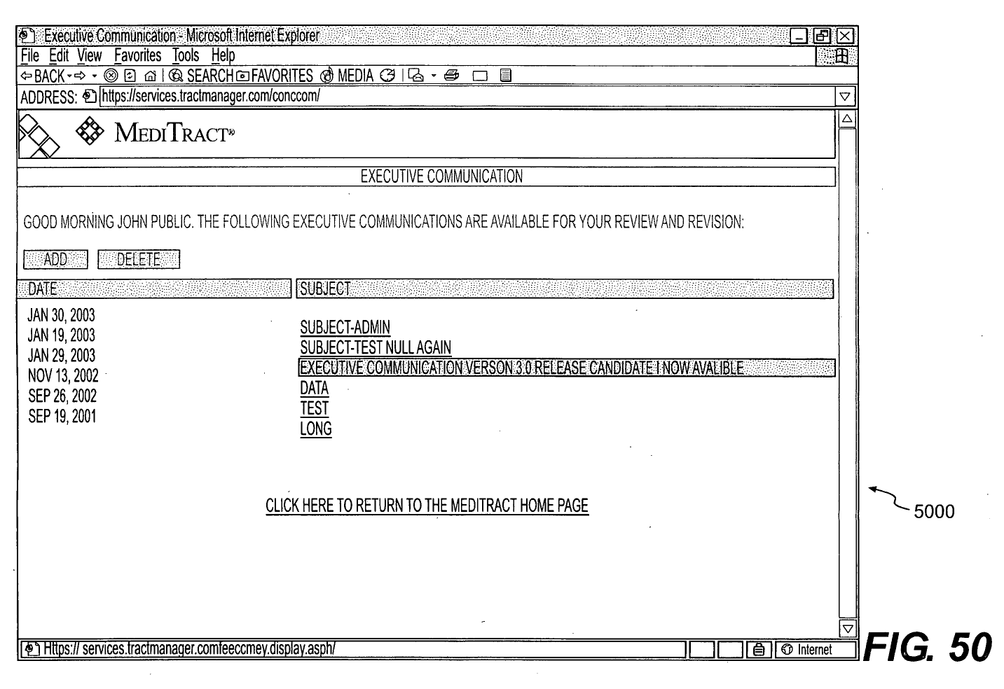

FIG. 50 depicts an exemplary web page that is provided upon selection of the Executive communication icon 604 shown in FIG. 6. In the FIG. 50 embodiment of the present invention, the Executive Communications web page 5000 provides a list of all messages that have been posted pertaining to pertinent information relating to an organization. In the FIG. 50 embodiment of the present invention, the Executive Communications web page 5000 provides modification options. The modification options include, but are not limited to, ADD 5002, EDIT 5004, and DELETE 5006. The modification options may be applied in a manner discussed above with respect to similar functions for the Contract Attachment/Note pages, the Critical Dates pages, and the Asset Log pages, etc., and thus will not be discussed again here.

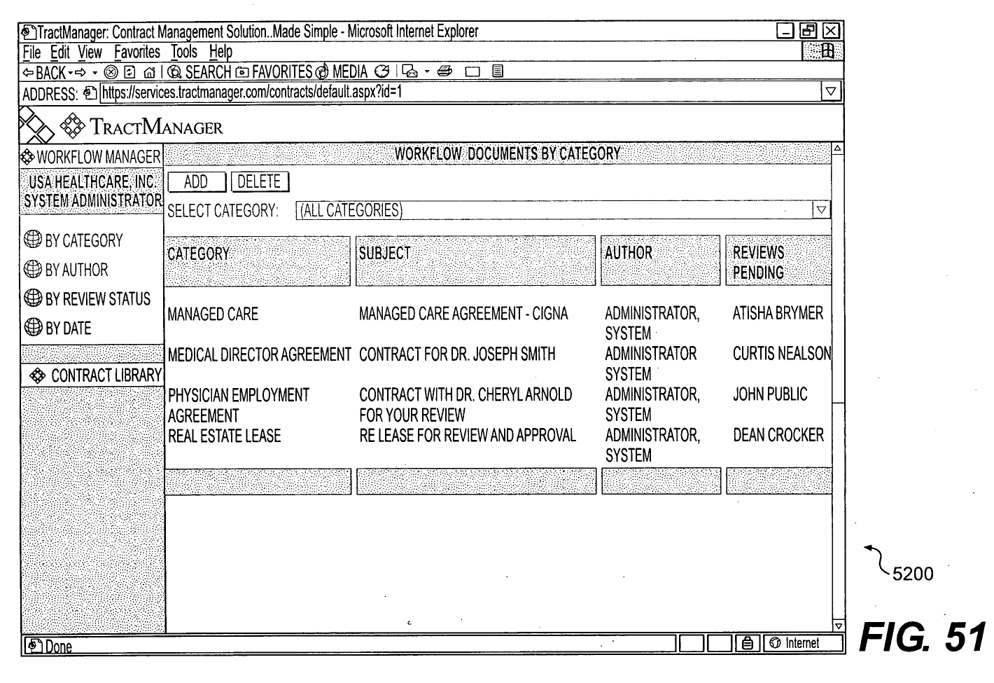

FIG. 51 depicts an exemplary web page that is provided upon selection of the Workflow icon 606 shown in FIG. 6. In the FIG. 51 embodiment of the present invention, the Workflow web page 5100 provides Workflow Documents that are stored by the Workflow Manager for an organization. The Workflow web page 5100 provides options in a navigation panel 5102 for specifying how to view the Workflow Documents. The options include, but are not limited to, Category, Author, Review Status, and Date. The Workflow web page 5100 provides modification options in a content panel 5104 for specifying how to route the Workflow Documents. The options include, but are not limited to, ADD 5106 and DELETE 5108. In the FIG. 51 embodiment of the present invention, the ADD 5106 option enables the routing of a new document for review or an existing document for revision.

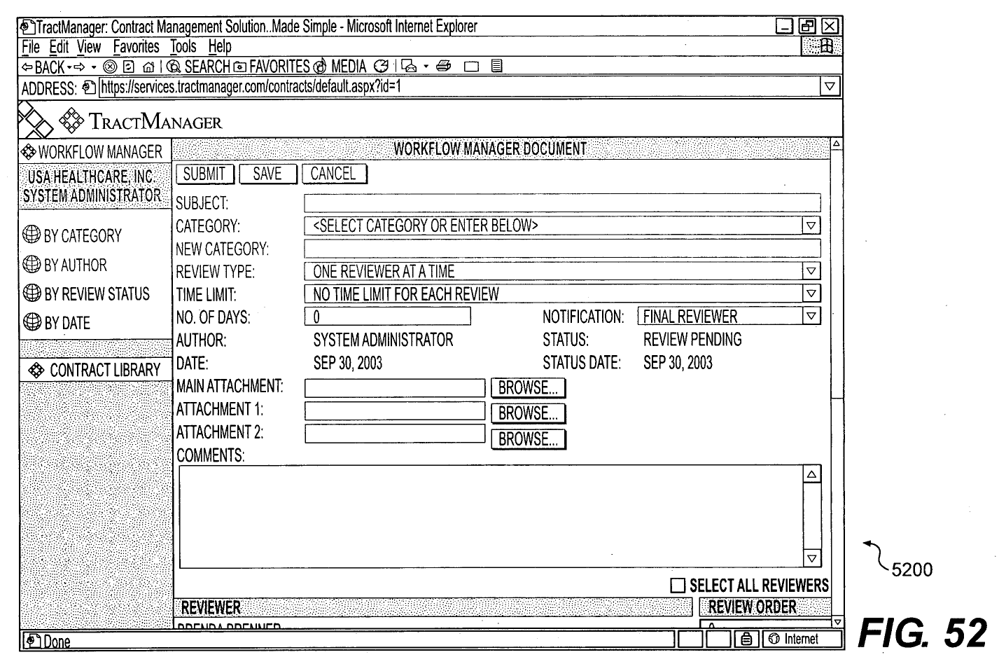

FIG. 52 depicts an exemplary web page that is provided upon selection of the Workflow icon 606 shown in FIG. 6. In the FIG. 52 embodiment of the present invention, the selection of the ADD option from the content panel 5104 of the workflow web page 5100 shown in FIG. 51 provides the workflow web page 5200. In the FIG. 52 embodiment of the present invention, the workflow web page 5200 includes textboxes and drop down list for the selection of information defining the workflow of the document. The textboxes include, but are not limited to, subject 5202, and new category 5204. The subject 5202 text box allows entry of the subject matter of the document. The new category 5204 text box allow entry of a new category for the document. The drop down lists include, but are not limited to, category 5206, review type 5208, time limit 5210, and number of days 5212. The Review Type drop down box is provided for you to select how this document is to be reviewed. The review type options include, but are not limited to, one reviewer at a time (this will allow only one reviewer to see the document at one time) and, all reviewers simultaneously (this will allow all users that you choose to see the document at once). The time limit drop down box allows the creator of the document to allow how long each user is allotted to view the specific document. Time limit options include, but are not limited to, no time limit for each reviewer, move to next reviewer after time limit expires, and keep sending reminders after time limit has expired. The number of days text box allows entry of the time limit that each user has to view the document. In the FIG. 52 embodiment of the present invention, documents may be attached to, and comment provided for, a workflow document. The order in which users are to receive a workflow document for review may be provided. A save option 5214 allow the workflow document to be saved. A submit option 5216 initiates the transmission of the workflow document to the selected users.

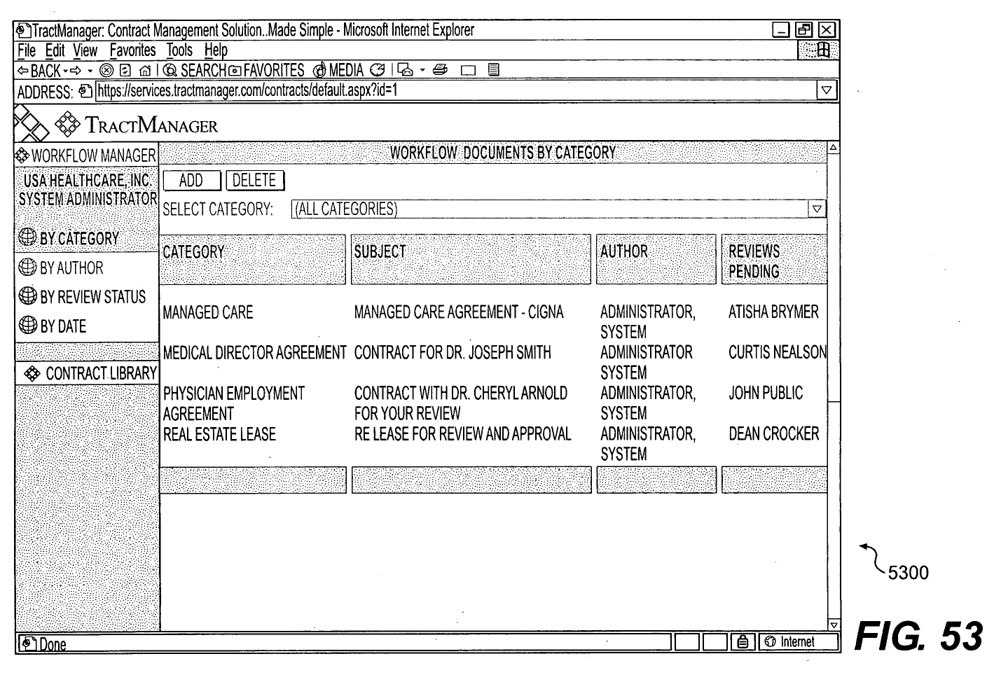

FIG. 53 depicts an exemplary web page that is provided to a recipient of invitations to participate in a review or revision of a workflow documents. In the FIG. 53 embodiment of the present invention, the workflow web page 5300 provides a listing of documents for review or revision by the recipient.

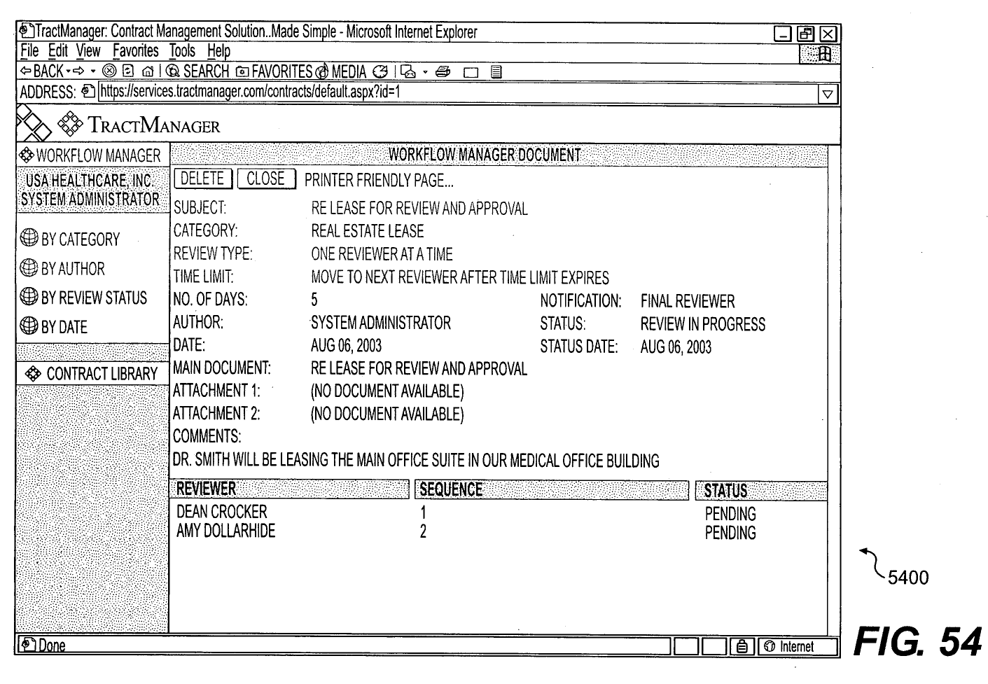

FIG. 54 depicts an exemplary web page that is provided upon selecting a workflow document listed on the workflow web page 5300 shown in FIG. 53. In the FIG. 54 embodiment of the present invention, the workflow web page 5400 provides the data and electronic document previously entered by an originator who posted and routed the workflow document. The workflow web page 5400 includes information related to subject, category, originator (Author), an attachment of the electronic document to review, and other information pertaining to this particular workflow document.

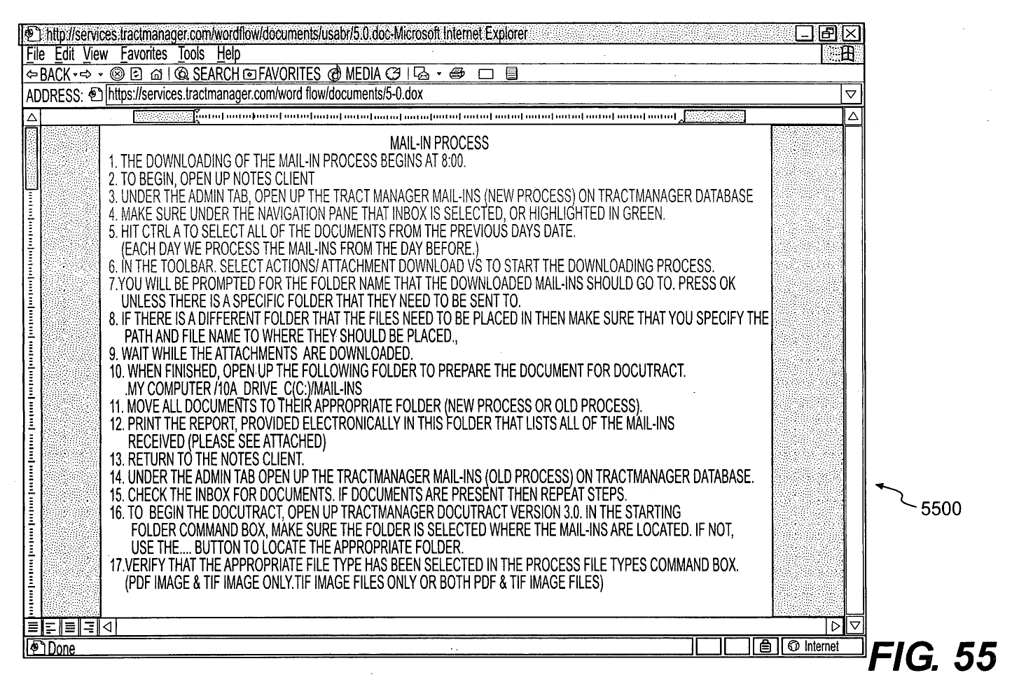

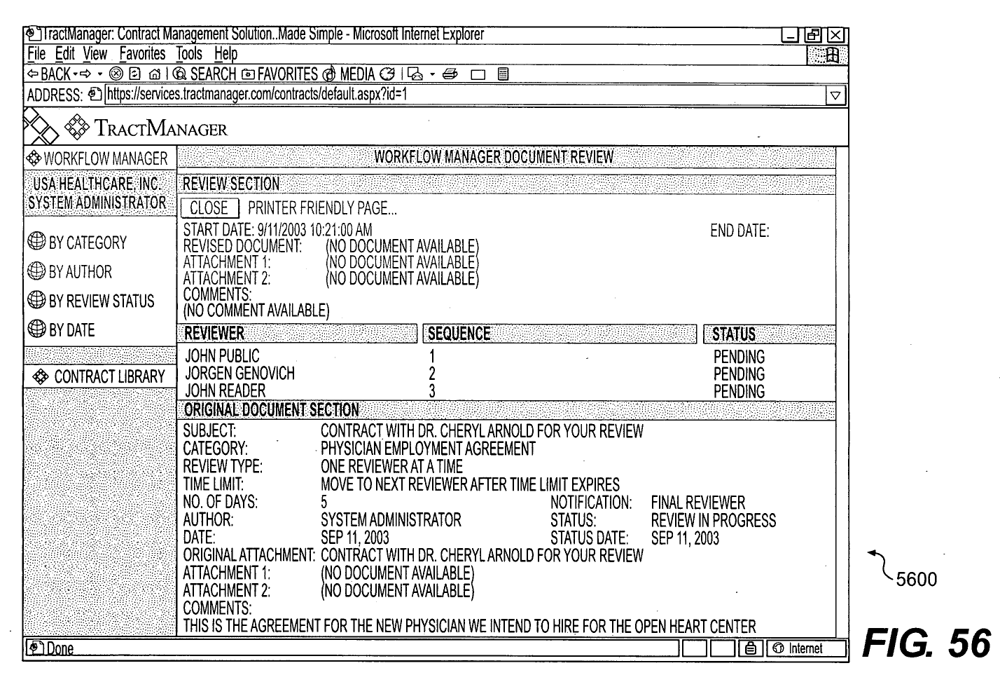

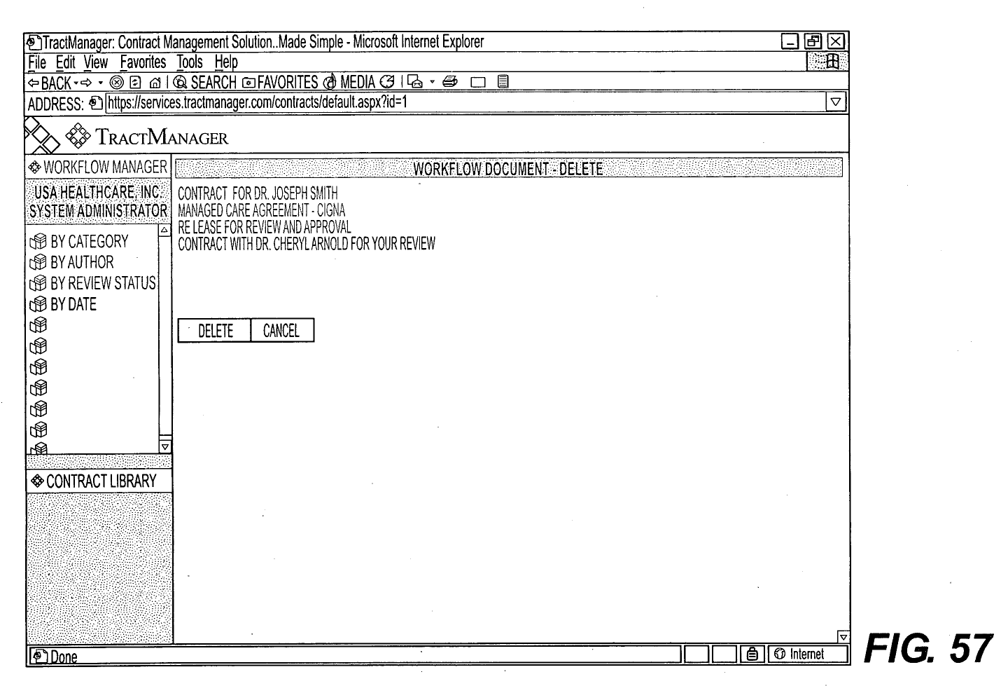

FIG. 55 depicts an exemplary web page that is provided upon selecting the attachment to a workflow document listed on the workflow web page 5400 shown in FIG. 54. In the FIG. 55 embodiment of the present invention, the workflow web page 5500 allows revising, formatting and manipulating the document in anyway required by using the features and functions available using word processing applications. The changes made to the document may be save using the word processing application. A back option navigates the recipient back the web page 5400.

Retuning here to FIG. 54. An EDIT option 5402 allows changes to the workflow document including comments regarding the review/revision, an attachment representing a copy of the recipient's revisions to be provided and, notification to the Originator (Author) that the review/revision process is completed. A save option 5404 saves changes and attachments to the workflow document, and notifies the Originator (Author) that your review is complete. This will be accompanied by another electronic mail message to the Originator (Author), informing them of your completion. A DELETE option 5406 DELETEs a document from the workflow in accordance with users access privileges.

What is claimed is:

1. A method of providing secure on-line access to a database of contract information, the method comprising the steps of:
identifying document access privileges for respective access role levels;
classifying a user with a respective access role level;
determining documents to provide to the user, and functionality performable on the documents based on the respective access role level; and
providing the documents and the functionality performable on the documents to the user.

2. The method of claim 1, further comprising: determining an information location to provide to the user based on the respective access role level;

3. The method of claim 2, further comprising: providing the information location to the user.

4. The method of claim 2, wherein the information location includes one of: a document location, a communications location, a document processing location.

5. The method of claim 1, further comprising: providing documents specific information in response to the selection of a function performable on a document.

6. The method of claim 5, further comprising: providing functionality performable on the document specific information.

7. The method of claim 6, further comprising: restricting the execution of a function performable on the document specific information based on the respective access role level.

8. A system for providing secure on-line access to a database of contract information comprising:
a first computer for:
identifying document access privileges for respective access role levels;
classifying a user with a respective access role level;
determining documents to provide to the user, and functionality
performable on the documents based on the respective access role level; and
providing the documents and the functionality performable on the documents to the user.

9. The system of claim 8, further comprising: the first computer for determining an information location to provide to the user based on the respective access role level;

10. The system of claim 9, further comprising: the first computer for providing the information location to the user.

11. The system of claim 9, wherein the information location includes one of: a document location, a communications location, a document processing location.

12 The system of claim 8, further comprising: the first computer for providing documents specific information in response to the selection of a function performable on a document.

13. The system of claim 12, further comprising: the first computer for providing functionality performable on the document specific information.

14. The system of claim 13, further comprising: the first computer for restricting the execution of a function performable on the document specific information based on the respective access role level.

15. The system of claim 8, further comprising: a network coupled to the first computer.

16. The system of claim 9, further comprising: a second computer, coupled to the network and the first computer, for accessing the first computer.
